(19) United States
(12) Patent Application Publication
(10) Pub. No.: US 2023/0318798 A1
(43) Pub. Date: Oct. 5, 2023

(54) REPORTING, CONFIGURATION AND TRANSMISSION METHOD FOR IAB NODE

(71) Applicant: Samsung Electronics Co., Ltd., Gyeonggi-do (KR)

(72) Inventors: Di SU, Beijing (CN); Chen QIAN, Beijing (CN); Peng LIN, Beijing (CN); Bin YU, Beijing (CN)

(21) Appl. No.: 18/021,111

(22) PCT Filed: Oct. 19, 2021
(86) PCT No.: PCT/KR2021/014617

§ 371 Date: Feb. 13, 2023

(30) Foreign Application Priority Data
Oct. 19, 2020 (CN) 202011118893.1
Jan. 8, 2021 (CN) 202110025865.3

(51) Int. Cl. H04L 5/14; H04W 72/0446; H04W 72/54

(52) U.S. Cl. CPC H04L 5/14; H04W 72/0446; H04W 72/54; H04W 72/23

(57) ABSTRACT

The disclosure relates to a communication method and system for converging a 5th-Generation (5G) communication system for supporting higher data rates beyond a 4th-Generation (4G) system with a technology for Internet of Things (IoT). The disclosure may be applied to intelligent services based on the 5G communication technology and the IoT-related technology, such as smart home, smart building, smart city, smart car, connected car, health care, digital education, smart retail, security and safety services. The disclosure provides a method executed by a first node in a wireless communication system, comprising: acquiring a physical resource related to a first duplex transmission; and performing uplink transmission and/or downlink transmission according to the acquired physical resource related to the first duplex transmission.

### TECHNICAL FIELD

The disclosure relates to the technical field of wireless communication, in particular to a reporting, configuration and transmission method for an integrated access and backhaul (IAB) node.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Co-ordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

### DISCLOSURE OF INVENTION

### Technical Problem

In line with the development of communication systems, there is a need for methods and apparatuses to design a physical resource configuration.

### Solution to Problem

The purpose of the disclosure is to design a physical resource configuration method, which can be used to make a distributed unit (DU) of an integrated access and backhaul (IAB) node acquire the transmission configuration information of its parent node and/or child node before performing the transmission scheduling. At the same time, a configuration method of invalid resources is also included, which can be used for the IAB node to dynamically configure invalid resources according to the reference signal transmission configuration of its parent node and/or child node, thus ensuring the accuracy of self-interference channel estimation. And, a signaling interaction method can be used for interacting configuration information related to full-duplex transmission between the IAB parent node and the IAB child node, thereby ensuring the performance of self-interference deletion of the IAB child node when performing the full-duplex communication.

According to an aspect of the disclosure, there is provided a method executed by a first node in a wireless communication system, comprising: acquiring a physical resource related to a first duplex transmission; and performing uplink transmission and/or downlink transmission according to the acquired physical resource related to the first duplex transmission. The physical resource related to the first duplex transmission includes time-domain and/or frequency-domain resources for performing the first duplex transmission; or time-domain and/or frequency-domain resources possible for performing the first duplex transmission.

In an embodiment of the disclosure, acquiring the physical resource related to the first duplex transmission is at least based on at least one of the following items: time division duplex (TDD) uplink and downlink configuration, resource validation configuration, and the first duplex capability of a communication node.

In an embodiment of the disclosure, the first node is a base station.

In an embodiment of the disclosure, the base station includes at least one of an eNB, a gNB or a distributed unit (IAB-DU) of an IAB node, or the first node is a terminal. In various embodiments, the terminal includes at least one of a mobile phone terminal, a computer terminal, or a mobile terminal (IAB-MT) of an IAB node.

In an embodiment of the disclosure, the first node is an IAB node, and the mobile terminal (MT) of the IAB node acquires a first duplex slot pattern A of a serving cell A where it is located, and the distributed unit (DU) of the IAB node acquires a first duplex slot pattern B of its serving cell B, and the first duplex slot pattern A and the first duplex slot pattern B indicate the first duplex slot pattern in the same transmission direction or respectively indicate the first duplex slot patterns in different transmission directions, and the transmission direction includes uplink and/or downlink.

In an embodiment of the disclosure, he first node is an IAB node, and when the DU of the IAB node acquires TDD uplink and downlink configuration, it applies the acquired TDD uplink and downlink configuration to configure TDD uplink and downlink configuration within its serving cell; or when the DU of the IAB node acquires the TDD uplink and downlink configuration, if the TDD uplink and downlink configuration configured within its serving cell is different from the acquired TDD uplink and downlink configuration, it reports a TDD uplink and downlink configuration conflict message to its IAB parent node.

In an embodiment of the disclosure, the method further comprises acquiring by the first node information including at least one of the following: an uplink minimum scheduling delay and/or a downlink minimum scheduling delay for scheduling physical transmission on a specific time-domain resource, an uplink maximum scheduling delay and/or a downlink maximum scheduling delay for scheduling physical transmission on a specific time-domain resource, or the scheduling delay configuration for uplink physical transmission and/or downlink physical transmission of a specific time-domain resource. The specific time-domain resource is a time-domain resource related to the first duplex transmission, and the scheduling delay indicates a time-domain interval between a time unit where scheduling grant information is transmitted and a time unit of scheduled physical transmission, and the physical transmission may include transmission of at least one of a physical uplink shared channel (PUSCH), a physical downlink shared channel (PDSCH), a channel state information reference signal (CSI-RS), or a sounding reference signal (SRS). Acquiring the uplink minimum scheduling delay and/or the downlink minimum scheduling delay for scheduling the physical transmission on the specific time-domain resource comprises acquiring the configuration of the uplink minimum scheduling delay and/or the downlink minimum scheduling delay in a master message block (MIB), a first system message block (SIB1) or other system message blocks (SIBs), and acquiring the uplink maximum scheduling delay and/or the downlink maximum scheduling delay for scheduling the physical transmission on the specific time-domain resource comprises acquiring the configuration of the uplink maximum scheduling delay and/or the downlink maximum scheduling delay in a master message block (MIB), a first system message block (SIB1) or other system message blocks (SIBs).

According to another aspect of the disclosure, there is provided a terminal in a wireless communication system, comprising: a transceiver; and a processor configured to control the transceiver to execute the method as described above.

According to another aspect of the disclosure, there is provided a base station in a wireless communication system, comprising: a transceiver; and a processor configured to control the transceiver to execute the method as described above.

According to another aspect of the disclosure, there is provided an IAB node, comprising: an MT; and a DU, and the IAB node is configured to execute the method as described above.

In an embodiment of the disclosure, when the communication node is an IAB node, the method for acquiring the full-duplex transmission bandwidth/bandwidth part may be that a frequency-domain unit of the serving cell of the IAB-DU is configured with a type, and the IAB-DU determines whether transmission and/or reception can be performed on the frequency-domain unit according to the configured type.

In an embodiment of the disclosure, the type of the frequency-domain unit can be configured through high-layer signaling or a downlink control channel. In a further embodiment, when the frequency-domain unit can be configured through both the high-layer signaling and the downlink control channel, the granularity of availability of the frequency-domain unit configured through the high-layer signaling is larger than that configured through the downlink control channel.

In an embodiment of the disclosure, configuring the type of the frequency-domain unit through the high-layer signaling comprises configuring the frequency-domain unit as one of the following on all time-domain units or a specific time-domain unit: available, dynamically indicating available, and unavailable.

In an embodiment of the disclosure, the configured type of the frequency-domain unit may be valid for all time-domain units or a specific time-domain unit (e.g., a symbol configured as hard and/or a symbol configured as soft and/or a symbol configured as NA), and the time-domain unit may be a symbol configured as hard and/or a symbol configured as soft and/or a symbol configured as NA.

In an embodiment of the disclosure, the method for configuring the frequency-domain unit type through the high-layer signaling can be at least one of the following two ways of: respectively configuring the type of each frequency-domain unit; or configuring each type of frequency-domain units separately.

In an embodiment of the disclosure, on a symbol configured as hard, the frequency-domain unit of the serving cell of the IAB-DU is configured as available or unavailable, or all the frequency-domain units of the serving cell of the IAB-DU are available resources by default.

In an embodiment of the disclosure, on a symbol configured as soft, the frequency-domain unit of the serving cell of the IAB-DU may be configured as dynamically indicating available or unavailable, or by default, all the frequency-domain units of the IAB-DU serving cell dynamically indicated as available.

In an embodiment of the disclosure, configuring the type of the frequency-domain unit through the downlink control channel comprises configuring the frequency-domain unit as available or unavailable on all time-domain units or a specific time-domain unit. The specific time-domain unit may be a time-domain symbol configured by the high-layer signaling and/or the downlink control channel as being capable of or possibly capable of performing signal transmission and/or signal reception. In a preferred embodiment, only the frequency-domain unit on the soft symbol of the serving cell of the IAB-DU is configured as available or unavailable with a manner of dynamic indication by the downlink control channel.

In an embodiment of the disclosure, configuring the type of the frequency-domain unit through the downlink control channel comprises that the IAB node acquires the configuration of the availability of one or more resources in the high-layer signaling, and determines whether one or more frequency-domain units on all time-domain units or a specific time-domain unit are available according to the resource availability configuration index indicated by the downlink control channel. In a further embodiment, the resource availability configuration at least includes configuration contents indicating the availability of each of one or more specific frequency-domain units, wherein the specific frequency-domain unit includes at least one of a frequency-domain unit configured as a dynamically indicating available type, all frequency-domain units within a soft symbol, and a frequency-domain unit which is within a soft symbol and is configured as a dynamically indicating available type.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### Advantageous Effects of Invention

According to various embodiments of the disclosure, methods and apparatuses to design a physical resource configuration, which can be used to make a DU of an IAB node acquire transmission configuration information of its parent node and/or child node before transmission scheduling, are provided. Accordingly, the improvement of the efficiency of the communication system can be achieved.

### BRIEF DESCRIPTION OF DRAWINGS

FIG. 1 illustrates an example wireless network according to an embodiment of the disclosure;

FIG. 2a illustrates an example wireless transmission path according to the disclosure;

FIG. 2b illustrates an example wireless reception path according to an embodiment of the disclosure;

FIG. 3a illustrates an example user equipment (UE) according to an embodiment of the disclosure;

FIG. 3b illustrates an example gNB according to an embodiment of the disclosure;

FIG. 4 illustrates an example in which the mobile terminal (MT) and the DU of the same IAB node perform downlink transmission on the same frequency at the same time according to an embodiment of the disclosure;

FIG. 5 illustrates a schematic diagram showing the implementation effect of an embodiment of the disclosure by taking the full-duplex transmission mode of the uplink transmission of the IAB-MT and uplink reception of the IAB-DU of the same IAB node as an example according to an embodiment of the disclosure;

FIG. 6 illustrates a flow chart of a signal transmission method according to an embodiment of the disclosure;

FIG. 7 illustrates a structure of a UE according to an embodiment of the disclosure; and

FIG. 8 illustrates a structure of a base station according to an embodiment of the disclosure.

### MODE FOR THE INVENTION

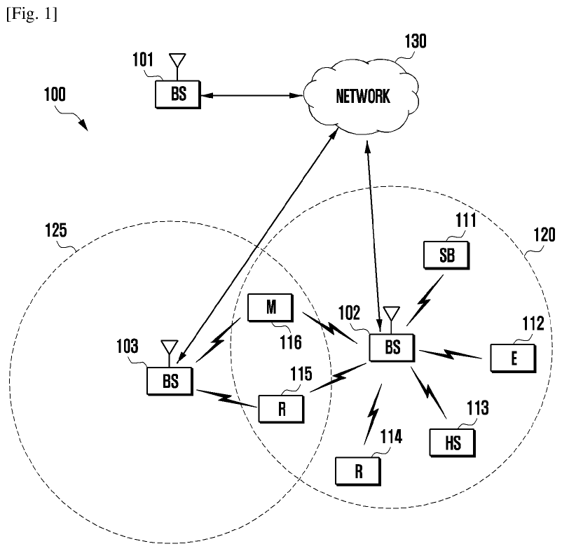

FIG. 1 through 8, discussed below, and the various embodiments used to describe the principles of the disclosure in this patent document are by way of illustration only and should not be construed in any way to limit the scope of the disclosure. Those skilled in the art will understand that the principles of the disclosure may be implemented in any suitably-arranged system or device.

The embodiments are described below only by referring to the accompanying drawings to explain various aspects. As used herein, the term “and/or” includes any and all combinations of one or more of the associated items listed. Expressions such as “at least one” and “at least a”, when preceding the element list, modify the entire element list instead of modifying individual elements of the list, so that the expression “at least one of a, b, and c” or similar expressions include only a, only b, only c, only a and b, only a and c, only b and c, and all of a, b and c.

The terms used in this specification will be briefly described, and the disclosure will be described in detail.

Regarding the terms in the various embodiments of the disclosure, in consideration of the functions of the structural elements in the various embodiments of the disclosure, general terms that are currently widely used are chose. However, the meanings of terms can be changed according to intentions, judicial precedents, the emergence of new technologies, etc. In addition, in some cases, terms that are not commonly used can be chose. In this case, the meanings of the terms will be described in detail in the corresponding part in the description of the disclosure. Therefore, the terms used in the various embodiments of the disclosure should be defined based on the meanings and description of the terms provided herein.

Any embodiment disclosed herein can be combined with any other embodiment, and references to “embodiments”, “some embodiments”, “alternative embodiments”, “various embodiments”, “one embodiment”, etc. are not necessarily mutually exclusive, but are intended to indicate that a particular feature, structure or characteristic described in connection with this embodiment may be included in at least one embodiment. Such terms used herein do not necessarily all refer to the same embodiment. Any embodiment may be combined inclusively or exclusively with any other embodiment in a manner consistent with the aspects and embodiments disclosed herein.

References to “or” can be construed as inclusive, so that any term described using “or” can indicate any one of a single, more than one, and all of the items.

Terms including ordinal numbers (such as first, second, etc.) can be used to describe various elements, but these elements are not limited by terms. The above terms are only used to distinguish one element from another. For example, without departing from the scope of the disclosure, the first element may be referred to as the second element, and similarly, the second element may also be referred to as the first element. The term “and/or” includes any combination of multiple related items or any one of the multiple related items.

FIG. 1 illustrates an example wireless network 100 according to an embodiment of the disclosure.

The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

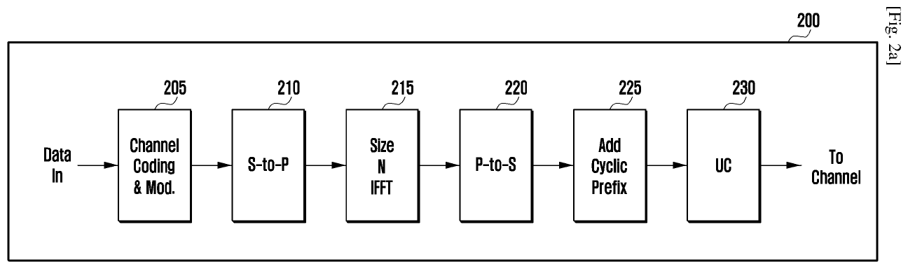

FIGS. 2a and 2b illustrate example wireless transmission and reception according to an embodiment of the disclosure.

In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

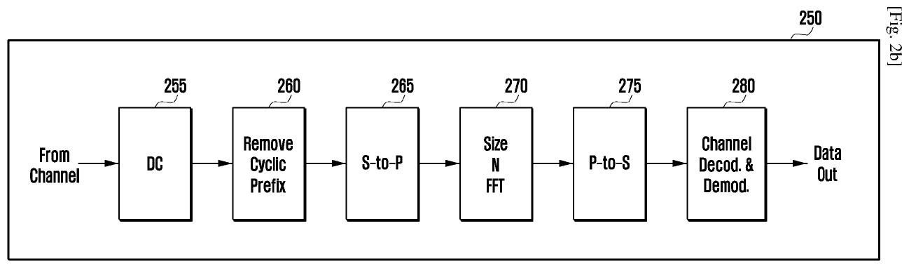

FIG. 3a illustrates an example user equipment (UE) 116 according to an embodiment of the disclosure.

The embodiment of UE 116 shown in FIG. 3a is for illustration only, and UEs 111-115 of FIG. 1 can have the same or similar configuration. However, a UE has various configurations, and FIG. 3a does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to an embodiment of the disclosure.

The embodiment of gNB 102 shown in FIG. 3b is for illustration only, and other gNBs of FIG. 1 can have the same or similar configuration. However, a gNB has various configurations, and FIG. 3b does not limit the scope of the disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

According to ITU's estimation, by 2020, the global monthly mobile data traffic will reach 62 Exa Bytes (EB, 1 EB=2³⁰ GB), and from 2020 to 2030, global mobile data services will even increase at an annual rate of about 55%. In addition, the proportion of video services and machine-to-machine communication services in mobile data services will gradually increase. In 2030, video services will be 6 times of non-video services, and machine-to-machine communication services will account for about 12% of mobile data services (see the article “IMT traffic estimates for the years 2020 to 2030, Report ITU-R M.2370-0”).

The rapid growth of mobile data services, especially the exponential growth of high-definition video and ultra-high-definition video services, has put forward higher requirements on the transmission rate of wireless communication. In order to meet the growing demand for mobile traffic, people need to propose new technologies on the basis of 4G or 5G to further improve the transmission rate and throughput of wireless communication systems. The full-duplex technology can further improve the spectrum utilization on the existing system. Different from the traditional half-duplex system using time-domain (time division duplex, TDD) or frequency-domain (frequency division duplex, FDD) orthogonal division for uplink and downlink, the full-duplex system allows the user's uplink and downlink to transmit simultaneously in the time and frequency domains. Therefore, the full-duplex system can theoretically achieve twice the throughput of the half-duplex system. However, because the uplink and downlink are at the same frequency and at the same time, the transmitted signal of the full-duplex system will produce strong self-interference on the received signal, and the self-interference signal may even be more than 120 decibels (dB) higher than the noise floor. Therefore, in order for the full-duplex system to work, the core issue is to design a solution to eliminate the self-interference to reduce the strength of the self-interference signal to at least the same level as the noise floor.

At present, there are many methods for self-interference elimination, which are roughly divided into antenna elimination methods, analog elimination methods, and digital elimination methods. Antenna elimination methods mainly refer to reducing the strength of the self-interference signal reaching the receiving antenna with manners of physical isolation and cancellation of received and transmitted signals and so on by designing the circuits of transmitting and receiving antennas. Analog elimination methods mainly refer to the elimination of self-interference signals in the analog domain of the receiving link (that is, before the analog-to-digital conversion). In the common self-interference cancellation structure, the antenna cancellation and the analog cancellation exist at the same time, which together make the signal input to the analog-to-digital converter have a reasonable dynamic range. Considering the implementation costs of the antenna cancellation circuit and the analog cancellation circuit, the digital cancellation is usually used after the analog cancellation in the engineering implementation to further process the residual self-interference signal after the analog cancellation.

As the name implies, digital elimination methods refer to the methods of eliminating self-interference signals in the digital domain at the receiving end (that is, after the analog-to-digital conversion). The basic principle is that a full-duplex device transmits a known reference signal on a specific physical resource and simultaneously receives a self-interference signal. According to the transmitted known reference signal, the full-duplex device can estimate the self-interference channel. On other physical resources, the full-duplex device simultaneously performs reception and transmission, and the transmitted signal causes interference to the receiving end through the self-interference channel. The full-duplex device can reconstruct the self-interference signal on these physical resources based on the estimated self-interference channel, and delete the re-constructed self-interference signal from the received digital-domain signal. It is worth noting that, in order to ensure the accuracy of the self-interference channel estimation, no full-duplex data transmission is performed on the physical resources for transmitting the reference signal used for the self-interference channel estimation. The physical resource occupied by the reference signal is called the pilot overhead. The greater the pilot overhead, the greater the transmission rate loss. In systems that use OFDM (Orthogonal Frequency Division Multiplexing) waveforms, such as LTE (Long-term Evolution), NR (New Radio), etc., the conventional operation to reduce the pilot overhead is transmission of the reference signal on several OFDM symbols in only one slot. Assuming that the channel in a slot is unchanged, the remaining OFDM symbols in the slot can use the channel estimated by the reference signal to perform self-interference deletion. However, due to the random phase noise between the transmitting end and the receiving end, different OFDM symbols within the same slot have different common phase errors (CPE). Therefore, the frequency-domain equivalent channels of different OFDM symbols have different phase deflections, which cause the channel estimation results of different OFDM symbols within the same slot to be unable to be reused.

It is worth noting that in order to ensure the accuracy of self-interference channel estimation, full-duplex transmission is not performed on the physical resource for transmitting a reference signal for the self-interference channel estimation, that is, transmissions of physical signals or physical channels in the receiving direction are not configured on the physical resource for transmitting the reference signal for the self-interference channel estimation. When a scenario of full-duplex transmission is a scenario of the same cell, that is, when the same base station schedules uplink transmission of one terminal and downlink transmission of another terminal respectively on the same time-frequency resource, or when the same base station schedules uplink transmission and downlink transmission of the same terminal on the same time-frequency resource, uplink and downlink transmissions are scheduled by the same base station, so the base station can configure the physical resource for transmitting the downlink reference signal as unavailable resources for uplink transmission, thus ensuring the accuracy of the self-interference channel estimation. However, considering the full-duplex transmission in an IAB scenario, two functional entities DU and MT of the same IAB node belong to two cells respectively at this time. When the MT and the DU of the same IAB node perform uplink transmission on the same frequency at the same time, or the MT and the DU of the same IAB node perform downlink transmission on the same frequency at the same time, among the MT and the DU of the same IAB node, there must be one entity transmitting signals and the other entity receiving signals, however, transmitting signals will cause self-interference to receiving signals.

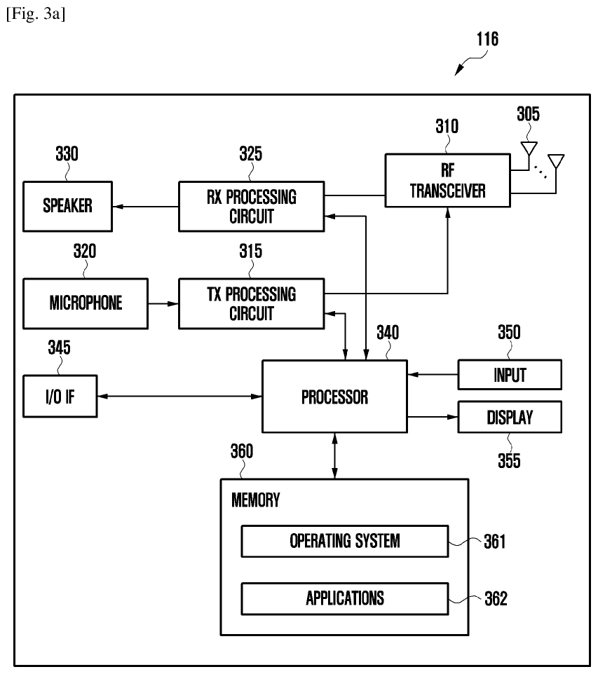

FIG. 4 illustrates an example in which the MT and the DU of the same IAB node perform downlink transmission on the same frequency at the same time according to an embodiment of the disclosure.

Different from the scenario of full-duplex transmission in the same cell, the transmitting link and the receiving link of full-duplex transmission of the same node in the IAB scenario belong to different cells respectively and are configured respectively by different base stations. Taking that the MT and the DU of the same IAB node perform downlink transmission on the same frequency at the same time in FIG. 4 as an example, the DU of the node IAB2 sends a downlink reference signal for self-interference channel estimation, while the MT of the node IAB2 receives downlink data according to the configuration of its parent node IAB1, and the downlink transmission physical resources configured by the parent node IAB1 should not include the physical resource used by the DU of the node IAB2 to send the downlink reference signal, so as to ensure the accuracy of the self-interference channel estimation of the node IAB2. Therefore, when scheduling the MT of its child node IAB2 (located in cell 1), the node IAB1 needs to acquire the related configuration of the DU of the node IAB2 transmitting the downlink reference signal to the MT of its child node IAB3 (located in cell 2), for example, the time-domain position of the DU of the node IAB2 transmitting the downlink reference signal, the frequency-domain position of the DU of the node IAB2 transmitting the downlink reference signal, etc. In the same way, when the full-duplex transmission in the IAB scene is that the MT and the DU of the same IAB node perform uplink transmission on the same frequency at the same time, the MT of the node IAB2 sends the uplink reference signal for self-interference channel estimation according to the configuration of its parent node IAB1, while the DU of the node IAB2 configures the MT of its child node IAB3 to avoid occupying the physical resource where the MT of the node IAB2 sends the uplink reference signal when performing uplink transmission. That is to say, it is also necessary to acquire the related configuration configured by the parent node IAB1 for the MT of the node IAB2 to send the uplink reference signal in advance, so as to ensure the accuracy of self-interference channel estimation.

To sum up, how to make the DU of IAB node know the related transmission configuration of its parent node when performing transmission configuration and how to make the DU of IAB node know the related transmission configuration of its child node when performing transmission configuration are problems to be solved urgently in order to realize full-duplex transmission in the IAB scene. However, the existing IAB system does not support the interaction of transmission-related configuration information between the parent node and the child node.

The purpose of the disclosure is to design a physical resource configuration method which can be used to make a DU of an IAB node acquire transmission configuration information of its parent node and/or child node before transmission scheduling. At the same time, it also includes a configuration method of an invalid resource, which can be used for IAB node to dynamically configure the invalid resource(s) according to the reference signal transmission configuration of its parent node and/or child node, thus ensuring the accuracy of self-interference channel estimation. And, a signaling interaction method can be used for interacting configuration information related to full-duplex transmission between an IAB parent node and an IAB child node, thereby ensuring the performance of self-interference deletion of the IAB child node when performing full-duplex communication.

In the disclosure, the first duplex transmission can be full-duplex transmission, and the full-duplex transmission is a form of enhanced duplex transmission, and the meaning of the full-duplex transmission includes, but is not limited to, the same communication device transmitting and receiving signals on the same time-domain and frequency-domain resources, and the same communication device transmitting and receiving signals respectively on different frequency-domain resources at the same time, but the locally sent signals cause self-interference to the received signals. The forms of the base station include, but are not limited to, eNB, gNB, IAB-DU, etc. The forms of the terminal include, but are not limited to, mobile phone terminal, computer terminal, IAB-MT, etc. The communication device includes, but is not limited to, terminal and base station, and the DU and the MT of the same IAB node are different functional entities of the same communication device. When the communication device is an IAB, the specific mode of the full-duplex transmission may be that the DU of the IAB node performs downlink transmission and the MT of the same node performs downlink reception on the same time-domain and frequency-domain resource; or that the DU of the IAB node performs uplink reception and the MT of the same node performs uplink transmission on the same time-domain and frequency-domain resource; or that the DU of the IAB node performs downlink transmission and the MT of the same node performs downlink reception on the same time-domain resource and different frequency-domain resources, and the transmission of the DU causes self-interference to the reception of the MT of the same node; or that the DU of the IAB node performs uplink reception and the MT of the same node performs uplink transmission on the same time-domain resource and different frequency-domain resources, and the transmission of the MT causes self-interference to the reception of the DU of the same node.

### Embodiment 1

In this embodiment, a physical resource acquisition method and a physical resource configuration method are described, which can be used for a base station and/or a terminal to acquire a physical resource related to full-duplex transmission, including time-domain and/or frequency-domain resources. The time-domain and/or frequency-domain resources related to full-duplex transmission may be time-domain and/or frequency-domain resources for performing full-duplex transmission or time-domain and/or frequency-domain resources possible for performing full-duplex transmission. Further, the time-domain resources include, but are not limited to, subframes, slots, mini slots, time-domain symbols (OFDM symbols), etc. Advantageously, the base station is a DU of an IAB node, and the terminal is an MT of an IAB node. Making the base station and/or the terminal acquire physical resources for performing full-duplex transmission or possible for performing full-duplex transmission is beneficial to making the base station and/or the terminal determine the physical resources for full-duplex transmission in advance before an actual scheduling occurs, thereby reducing the signaling overhead of the configuration related to full-duplex transmission and/or the preparation time for the full-duplex transmission.

A method for a communication node to acquire a physical resource related to full-duplex transmission is characterized in that the communication node determines time-domain symbols related to full-duplex transmission according to at least one of TDD uplink and downlink configuration, resource validation configuration and the full-duplex capability of the communication node. This method for acquiring the time-domain resources related to full-duplex transmission has the advantages that the communication node acquires the time-domain resources related to full-duplex transmission in an implicit manner without special signaling configuration, which can save the signaling overhead.

The TDD uplink and downlink configuration refers to a configuration parameter for determining whether the transmission on any time-domain symbol is uplink, downlink or flexible, and the specific mode of the TDD uplink and downlink configuration can be high-layer signaling and/or downlink control information (DCI). The TDD uplink and downlink configuration used to determine the time-domain symbols related to full-duplex transmission can be the TDD uplink and downlink configuration of one or more links (or one or more serving cells). For example, for an IAB node, the TDD uplink and downlink configuration can be the TDD uplink and downlink configuration of the serving cell A where the IAB-MT is located acquired by the IAB-MT and the TDD uplink and downlink configuration of the serving cell B of the IAB-DU acquired by the IAB-DU. The resource validation configuration can be used to determine whether any time-domain symbol is an available resource of the current serving cell. For example, for an IAB node, the resource validation configuration can be a configuration whether one or more time-domain symbols of the serving cell B of the IAB-DU acquired by the IAB-DU are available resources. For example, the time-domain symbols indicated as available can be hard-type symbols or soft-type symbols indicated as available, while the time-domain symbols indicated as unavailable may be unavailable-type symbols or soft-type symbols indicated as unavailable. The full-duplex capability of the communication node is the capability reported by the communication node whether to support the full-duplex transmission. Specifically, the specific contents of the reported full-duplex capability at least include one of the following: whether the communication node supports the full-duplex transmission; whether the communication node (IAB) supports the full-duplex transmission in which the DU performs downlink transmission and the MT of the same node performs downlink reception; whether the communication node (IAB) supports the full-duplex transmission in which the DU performs uplink reception and the MT of the same node performs uplink transmission; a time-domain symbol and/or a frequency band where the communication node can support the full-duplex transmission; a time-domain symbol and/or a frequency band where the communication node (IAB) can support the full-duplex transmission in which the DU performs downlink transmission and the MT of the same node performs downlink reception; and a time-domain symbol and/or a frequency band where the communication node (IAB) can support the full-duplex transmission in which the DU performs uplink reception and the MT of the same node performs uplink transmission. The frequency band supporting the full-duplex transmission may be one or more bandwidth parts, or one or more physical resource blocks. The following gives a specific instance that a communication node IAB reports the transmission capability. The transmission capability reported by the communication node IAB can be signaling indicating whether any combination of the following transmission modes is supported: only supporting time division multiplexing of the IAB-MT and the IAB-DU of the same node, simultaneous reception of the IAB-MT and the IAB-DU of the same node, simultaneous transmission of the IAB-MT and the IAB-DU of the same node, downlink reception of the IAB-MT and downlink transmission of the IAB-DU of the same node, uplink transmission of the IAB-MT and uplink reception of the IAB-DU of the same node. This design of the reporting content of the full-duplex capability can support the communication node IAB to report accurate transmission capability information under various possible hardware and software implementations, thus ensuring that the parent node performs the reasonable resource configuration. Furthermore, the indication of whether to support downlink reception of the IAB-MT and downlink transmission of the IAB-DU of the same node and the indication of whether to support uplink transmission of the IAB-MT and uplink reception of the IAB-DU of the same node can be an indication field, for example, indicating whether to support the transmission mode of downlink reception of the IAB-MT and downlink transmission of the IAB-DU of the same node and the transmission mode of uplink transmission of the IAB-MT and uplink reception of the IAB-DU of the same node at the same time. This design takes into account that when the IAB node supports full-duplex transmission, the hardware design of the IAB must ensure that the IAB-MT and the IAB-DU of the same node have certain antenna isolation capability, and the antenna isolation capability is applicable to the above two full-duplex transmission modes. And, to indicate the capability of downlink reception of the IAB-MT and downlink transmission of the IAB-DU of the same node, and/or to indicate the capability of uplink transmission of the IAB-MT and uplink reception of the IAB-DU of the same node, specific content may also include an indication of whether to support performing transmission on the same time-domain and frequency-domain resources. This design takes into account that when the IAB node cannot fully support full-duplex transmission, downlink reception of the IAB-MT and downlink transmission of the IAB-DU of the same node can be performed on different time-domain resources and/or frequency-domain resources in a non-full-duplex manner, or uplink transmission of the IAB-MT and uplink reception of the IAB-DU of the same node are performed on different time-domain resources and/or frequency-domain resources. And, the communication node IAB reports specific time-domain resources and/or frequency-domain resources to which the transmission capability is applicable, for example, the communication node IAB reports the bandwidth part and/or time-domain symbol for the specific transmission capability which can be downlink reception of the IAB-MT and downlink transmission of the IAB-DU of the same node, and/or uplink transmission of the IAB-MT and uplink reception of the IAB-DU of the same node. This design can separate the physical resources of full-duplex transmission from those of non-full-duplex transmission. Considering that transmission of a physical signal, resource allocation and the like during full-duplex transmission are different from those during non-full-duplex transmission, making the communication node IAB and its parent node agree on the physical resources of full-duplex transmission in this way is beneficial to the rational use of physical resources.

Specifically, a specific implementation of a communication node IAB acquiring a physical resource related to full-duplex transmission may be that the IAB node determines whether any time-domain symbol is a time-domain symbol of full-duplex transmission according to the combination mode of the TDD uplink and downlink configuration of the serving cell A where the IAB-MT is located acquired by the IAB-MT and the TDD uplink and downlink configuration of the serving cell B of the IAB-DU acquired by the IAB-DU. For example, the conditions for determining that the time-domain symbol #i is a time-domain symbol of full-duplex transmission of the IAB node at least include that for the symbol, the combination of the TDD uplink and downlink configuration acquired by the IAB-MT and the TDD uplink and downlink configuration acquired by the IAB-DU of the same node meets one of the following conditions: at least one of the TDD uplink and downlink configurations for the same time-domain symbol #i are flexible, or both are downlink, or both are uplink. Furthermore, the IAB node determines a time-domain symbol for full-duplex transmission among specific time-domain symbols according to at least one of the following: the resource validation indication indicating the serving cell B of the IAB-DU acquired by the IAB-DU, the full-duplex capability reported by the IAB node. The specific time-domain symbols can be time-domain symbols determined by the IAB node according to the time-domain symbols among the TDD uplink and downlink configurations acquired by the IAB-MT and the IAB-DU of the same node that meet a certain combination mode, for example, at least one of the TDD uplink and downlink configurations of the same time-domain symbols are flexible, and/or both are downlink, and/or both are uplink. Specifically, the method for the IAB node to determine a time-domain symbol for full-duplex transmission among specific time-domain symbols according to the resource validation indication acquired by the IAB-DU may be that the time-domain symbol which is an available symbol according to the resource validation indication acquired by the IAB-DU among specific time-domain symbols is a time-domain symbol for full-duplex transmission. Specifically, the method for the IAB node to determine the time-domain symbol for full-duplex transmission according to the reported full-duplex capability may include one of the following: when the IAB node reports that it supports the full-duplex capability, the specific time-domain symbols are the time-domain symbols of full-duplex transmission; when the IAB node reports time-domain symbols supporting the full-duplex capability, the time-domain symbols that meet supporting full-duplex capability among the specific time-domain symbols are time-domain symbols of full-duplex transmission; when the IAB node reports the bandwidth part supporting the full-duplex capability, the specific time-domain symbols on the bandwidth part are the time-domain symbols of full-duplex transmission; when the IAB node reports the bandwidth part supporting the full-duplex capability, all the time-domain symbols on the bandwidth part are time-domain symbols of full-duplex transmission. The specific time-domain symbols can be time-domain symbols determined by the IAB node according to the time-domain symbols among the combinations of the TDD uplink and downlink configurations acquired by the IAB-MT and the IAB-DU of the same node that meet a certain combination mode.

A method for a communication node to acquire a physical resource related to full-duplex transmission is characterized in that the communication node determines the physical resource related to full-duplex transmission according to at least one of the following configurations: full-duplex transmission frequency-domain resource configuration and full-duplex transmission time-domain resource configuration. Specifically, when the communication node is an IAB node, the configuration may be the configuration of full-duplex transmission physical resources acquired by the IAB-DU and/or the IAB-MT, which may be configured by the parent node of the IAB node.

The specific configuration content of full-duplex transmission frequency-domain resources can be a bandwidth containing one or more physical resource blocks that can be allocated to full-duplex transmission, or a bandwidth part used for full-duplex transmission; and, according to the configured full-duplex transmission bandwidth/bandwidth part, the frequency-domain allocation of the communication node performing the full-duplex transmission should be within the full-duplex transmission bandwidth/bandwidth part. Specifically, the communication node (e.g., an IAB node, a terminal) acquires the bandwidth/bandwidth part of full-duplex transmission, and performs full-duplex transmission or uplink or downlink transmission related to full-duplex transmission within the configured bandwidth/bandwidth part. Specifically, when the communication node is a terminal of non-IAB MT, the method for acquiring the full-duplex transmission bandwidth/bandwidth part may be that the terminal receives high-layer signaling, or DCI or user group DCI to obtain the indication of the bandwidth/bandwidth part of the full-duplex transmission. And, when the communication node is an IAB node, the method for acquiring the full-duplex transmission bandwidth/bandwidth part may be that the IAB-DU is provided with the configuration of the full-duplex transmission bandwidth/bandwidth part, and the configuration information may be the high-layer signaling received by the IAB-MT of the same node, or the related indication of DCI, or the related indication in user group DCI. And, when the communication node is an IAB node, the specific configuration of the full-duplex transmission bandwidth/bandwidth part provided for the IAB-DU can also be a bandwidth/bandwidth part A for the IAB-DU and the IAB-MT of the same node to perform downlink transmission on the same symbol, and/or a bandwidth/bandwidth part B for the IAB-DU and the IAB-MT of the same node to perform uplink transmission on the same symbol. The time-domain symbol where the IAB-DU and the IAB-MT of the same node perform uplink or downlink transmission on the configured bandwidth/bandwidth part may be a time-domain resource related to full-duplex transmission, such as the full-duplex slot determined according to the method in Embodiment 1, etc.

And, when the communication node is an IAB node, the method for acquiring the full-duplex transmission bandwidth/bandwidth part may be that the frequency-domain unit of the serving cell of the IAB-DU is configured with a type, and the IAB-DU determines whether it can perform transmission and/or reception on the frequency-domain unit according to the configured type. The meaning of the frequency-domain unit can be at least one of the following: a bandwidth part, a physical resource block (PRB), a physical resource block group (RBG), a frequency band with a fixed starting position and a fixed bandwidth size (for example, X MHz with a fixed starting frequency-domain position within the system bandwidth, where X can be 5, 10, 15, 20, 50, 100, etc.), a frequency band with a configurable starting position and a fixed bandwidth size (for example, X MHz with a configurable starting frequency-domain position within the system bandwidth, where X can be 5, 10, 15, 20, 50, 100, etc.), and a frequency band with a starting position and a bandwidth size both of which are configurable (for example, X MHz with a configurable starting frequency-domain position within the system bandwidth, where X is configurable). The advantage of this design is that the configuration information necessary for the IAB node can be provided, which is convenient for the IAB-DU to determine the frequency-domain resource configuration of its serving cell. Further, when the IAB node acquires that the frequency-domain unit being possible for transmission and/or reception configured for the serving cell of the IAB-DU is located on the same time-domain symbol with the frequency-domain unit performing transmission and/or reception configured for the IAB-MT of the node, and if the IAB-MT performs uplink transmission and the IAB-DU performs uplink reception on the same time-domain symbol, or the IAB-MT performs downlink reception and the IAB-DU performs downlink transmission on the same time-domain symbol, the frequency-domain unit is the bandwidth/bandwidth part of full-duplex transmission.

And, specifically, the configuration of the type can be configured by higher-layer signaling, and the configured content at least includes one of the following: available (e.g., hard), dynamically indicating available (e.g., soft), and unavailable (e.g., NA (not available)). The meaning of the dynamically indicating available may be that the IAB-DU further determines whether the frequency-domain resource dynamically indicated as available is available or unavailable according to the indication of the downlink control channel. The advantage of this design is that the high-layer signaling provided for the IAB node to configure the type of the frequency-domain unit is convenient for the serving cell of the IAB-DU to plan, use and configure frequency-domain physical resources quasi-statically. And, the method for configuring the type of the frequency-domain unit through high-layer signaling may be configuring the type of each frequency-domain unit separately, for example, for each frequency-domain unit or each frequency-domain unit on a specific time-domain unit (e.g., the frequency-domain unit on a symbol configured as hard and/or soft and/or NA), configuring its type as available or unavailable respectively by high-layer signaling; or configuring its type as available, dynamically indicating available or unavailable; or configuring its type as dynamically indicating available or unavailable; or configuring its type as available or dynamically indicating available; or configuring whether its type is dynamically indicating available (the default state is available by default or the default state is unavailable by default); or configuring whether its type is available (the default state is unavailable by default). Or, the method for configuring the type of the frequency-domain unit by high-layer signaling may also be configuring each type of frequency-domain unit separately, for example, for any configuration type, configuring one or more frequency-domain units belonging to the configuration type by high-layer signaling, for example, indicating whether N frequency-domain units belong to the configuration type with N bits, in which any one of the N bits has a corresponding relationship with a specific frequency-domain unit and indicates whether the specific frequency-domain unit belongs to the configuration type. The types of the frequency-domain units configured above can be valid for all time-domain units or a specific time-domain unit (e.g., a symbol configured as hard and/or a symbol configured as soft and/or a symbol configured as NA). And, further, on the frequency-domain unit configured as available, the serving cell of the IAB-DU can send and/or receive signals on any symbol or specific symbol; and/or, on the frequency-domain unit configured as unavailable, the serving cell of the IAB-DU neither send nor receive signals on any symbol or specific symbol; and/or on the frequency-domain unit configured as dynamically indicating available, the serving cell of the IAB-DU can determine whether it is possible to send and/or receive signals on any symbol or specific symbol according to the dynamic indication. The meaning of the specific symbol can be at least one of the following: a symbol configured as hard and soft, a symbol configured as soft, a symbol configured as hard, a symbol configured as soft and dynamically configured as available by the downlink control channel (e.g., DCI format 2_5). Preferably, on the symbol configured as hard, the frequency-domain unit of the serving cell of IAB-DU is configured as available or unavailable, or all the frequency-domain units of the serving cell of the IAB-DU are available resources by default. The advantage of this design is that the available frequency-domain resources of the serving cell of the IAB-DU on the hard symbol can be guaranteed to be quasi-static configuration, which is convenient for the serving cell of the IAB-DU to configure quasi-static transmission, such as for system messages, random access procedure Msg1-Msg4, downlink control channels, etc. And, preferably, on the symbol configured as soft, the frequency-domain unit of the serving cell of the IAB-DU can be configured as dynamically indicating available or unavailable, or by default, all the frequency-domain units of the serving cell of the IAB-DU are resources dynamically indicated as available. The advantage of this design is that supporting the dynamic indication of the type of the frequency-domain unit on the time-domain symbol (i.e., soft symbol) dynamically indicated as available can improve the flexibility of resource configuration.

And, specifically, the IAB node determines that the frequency-domain unit of the serving cell of the IAB-DU is available or unavailable on all time-domain units or a specific time-domain unit through the indication of the downlink control channel. The meaning of the specific time-domain unit can be a time-domain symbol configured by the high-layer signaling and/or the downlink control channel to be able or possible to perform signal transmission or signal reception, for example, a symbol configured as hard and soft, a symbol configured as soft, a symbol configured as hard, and a symbol configured as soft and dynamically configured as available by the downlink control channel (e.g., DCI format 2_5). The advantage of this design is that the parent node IAB-DU can be allowed to dynamically configure the frequency-domain resources of the serving cell of its child node IAB-DU as available or unavailable, which provides the flexibility in using frequency-domain resources within the serving cell of the parent node IAB-DU, and ensures the reception performance of critical physical channels and/or physical signals or physical channels and/or physical signals with high de-modulation performance requirements within its serving cell, for example, frequency-domain resources used by synchronization signal blocks within the serving cell of the parent node IAB-DU and so on. Preferably, only the frequency-domain unit on the soft symbol of the serving cell of the IAB-DU is configured as available or unavailable with a manner of dynamic indication by the downlink control channel. This design can reduce the redundancy of time-frequency resource availability configuration. For example, a symbol configured as hard indicates that all frequency-domain resources on the symbol are available resources, and there is no need to dynamically configure the frequency-domain resource availability. A specific implementation of indicating whether the frequency-domain unit of the serving cell of the IAB-DU is available through the downlink control channel may be that the IAB node acquires one or more resource availability configurations in the high-layer signaling and determines whether one or more frequency-domain units on all time-domain units or a specific time-domain unit are available according to the resource availability configuration index indicated by the downlink control channel. The resource availability configuration at least includes the configuration content indicating the availability of each of one or more specific frequency-domain units, and the meaning of the specific frequency-domain unit at least includes one of the following: a frequency-domain unit configured as a dynamically-indicating-available type, all the frequency-domain units within a soft symbol, and a frequency-domain unit within a soft symbol configured as the dynamically-indicating-available type. Specifically, the resource availability configuration may include frequency-domain resource availability indication, or both frequency-domain and time-domain resource availability indication. A specific implementation may be containing the indication of frequency-domain unit availability indication in the Availability Combination configuration. In addition, the specific content of the frequency-domain resource availability indication configured by the high-layer signaling may be indicating whether each of one or more frequency-domain units is available or unavailable in a bitmap manner, for example, indicating the availability of N frequency-domain units with N bits, each of which has a corresponding relationship with one frequency-domain unit for indicating whether the frequency-domain unit is available or unavailable. Furthermore, the IAB node determines the availability of the frequency-domain units on all time-domain symbols within one or more slots within the serving cell of the IAB-DU according to the frequency-domain resource availability indication field configured by the same high-layer signaling; or, the IAB node acquires the indications of multiple frequency-domain resource availability in-dication fields, and respectively determines the availability of the frequency-domain units on all time-domain symbols within different slots within the serving cell of the IAB-DU; or, the IAB node acquires the indications of multiple frequency-domain resource availability indication fields, and respectively determines the availability of the frequency-domain unit on each time-domain symbol within the same slot within the serving cell of the IAB-DU; or, the IAB node acquires the indications of multiple frequency-domain resource availability indication fields, and respectively determines the availability of frequency-domain units on time-domain symbols of the same type within the same slot within the serving cell of the IAB-DU. The meaning of time-domain symbols of the same type is one of the following: downlink symbols, uplink symbols and flexible symbols. Preferably, when the frequency-domain resource availability of the serving cell of the IAB-DU can be configured either quasi-statically through the high-layer signaling or dynamically through the downlink control channel, the granularity of frequency-domain unit availability configured through the high-layer signaling is larger than that configured through the downlink control channel. For example, the availability type of a bandwidth part is configured through the high-layer signaling, and the availability of a physical resource block (PRB) or a physical resource block group (RBG) within the bandwidth part is configured through the downlink control channel. The advantage of this design is that the granularity of frequency-domain unit availability configured by the high-layer signaling and the granularity of frequency-domain unit availability configured by the downlink control channel are reasonably allocated, so as to avoid redundancy of the two signaling configurations and to make a reasonable compromise between flexibility and effectiveness of configuration.

The specific configuration content of time-domain resource configuration of full-duplex transmission can be time-domain symbols, slots, subframes, or other time units that can be allocated to the full-duplex transmission. Taking the slot configuration of the full-duplex transmission as an example, an instance is given below. The communication node IAB node acquires the pattern configuration usable for slots of full-duplex transmission, which indicates the slots that can be allocated to the full-duplex transmission among multiple continuous slots, and be valid periodically and repeatedly in time. For example, the pattern of N slots, including slots which can be allocated to the full-duplex transmission and slots which cannot be allocated to the full-duplex transmission, is indicated with a bitmap, and the pattern configuration which can be used for slots of the full-duplex transmission is valid repeatedly in a cycle with a length of N′ slots, and indicates the slots which can be allocated to the full-duplex transmission among the first N slots within each cycle. And, further, the communication node can further determine the time-domain symbols that can be actually allocated to the full-duplex transmission within the slot of the full-duplex transmission according to the combination mode of the TDD uplink and downlink configuration of the serving cell A where the IAB-MT is located acquired by the IAB-MT and the TDD uplink and downlink configuration of the serving cell B of the IAB-DU acquired by the IAB-DU. For example, the conditions for determining that the time-domain symbol #i within the slot of the full-duplex transmission is a time-domain symbol of the full-duplex transmission of the IAB node at least include that for the symbol, the combination of the TDD uplink and downlink configuration acquired by the IAB-MT and the TDD uplink and downlink configuration acquired by the IAB-DU of the same node meets one of the following conditions: at least one of the TDD uplink and downlink configurations for the same time-domain symbol #i are flexible, or both are downlink, or both are uplink. It should be noted that indicating the time unit pattern of full-duplex transmission with a bitmap is also applicable to other time units than slots. This design can realize relatively flexible quasi-static full-duplex time-domain resource configuration with less signaling overhead.

According to the above instance, there is also an improved full-duplex time unit configuration mode. Also taking the pattern configuration of slots of full-duplex transmission as an example, the specific implementation can be that the IAB-MT acquires the full-duplex slot pattern A of the serving cell A where it is located and the IAB-DU acquires the full-duplex slot pattern B of the serving cell B of the IAB-DU. The full-duplex slot pattern A and the full-duplex slot pattern B can both indicate full-duplex slot patterns in the same transmission direction, or indicate full-duplex slot patterns in different transmission directions respectively. For example, the full-duplex slot pattern A can be used to configure a full-duplex slot that can be used for downlink reception of the IAB-MT and downlink transmission of the IAB-DU of the same node; and the full-duplex slot pattern B is used to configure a full-duplex slot that can be used for uplink transmission of the IAB-MT and uplink reception of the IAB-DU of the same node. Since full-duplex transmission has a greater impact on the receiving end of the IAB (IAB-DU performing uplink reception and IAB-MT performing downlink reception), this design makes the receiving devices of the IAB node (IAB-DU uplink reception and IAB-MT downlink reception) acquire the slot configuration respectively in full-duplex transmission in different transmission directions. It should be noted that the principle of this configuration mode is also applicable to other time units than slots.

According to the current protocol, the TDD uplink and downlink configuration acquired by the node IAB-DU (configured by its parent node for the serving cell of the IAB-DU) may not be completely consistent with the TDD uplink and downlink configuration acquired by the terminal within the serving cell of the IAB-DU (configured by the IAB-DU). In order to ensure that the communication node IAB can effectively determine the full-duplex slot according to the combination of the TDD uplink and downlink configuration acquired by the IAB-MT and the TDD uplink and downlink configuration acquired by the IAB-DU of the same node in the disclosure, a method for a communication node to acquire a time-domain resource related to full-duplex transmission can also include the following contents: when the IAB-DU acquires the TDD uplink and downlink configuration (configured by its parent node for the serving cell of the IAB-DU), the acquired TDD uplink and downlink configuration is applied to configure the TDD uplink and downlink configuration within its serving cell; or, when the IAB-DU acquires the TDD uplink and downlink configuration (configured by its parent node for the serving cell of the IAB-DU), if the TDD uplink and downlink configuration configured by the IAB-DU within its serving cell is different from the TDD uplink and downlink configuration acquired by the IAB-DU, the IAB-DU reports a TDD uplink and downlink configuration conflict message to its parent node, the specific meaning of which can be that the TDD uplink and downlink configuration of the IAB-DU within its serving cell have conflict indications, or the TDD uplink and downlink configurations have different time unit indications.

### Embodiment 2

In this embodiment, a time-domain resource allocation method is described, which is used to ensure that the time when the MIB-MT receives the scheduling signaling is always earlier than the time when the IAB-DU of the same node sends the scheduling signaling in the full-duplex transmission. The beneficial effect of this design is that it can ensure that the IAB-DU first acquires the uplink transmission or downlink reception configuration of the AB-MT scheduled by the parent node, and determines the scheduling situation of the present serving cell, for example, whether to perform full-duplex transmission and perform full-duplex related scheduling and configuration.

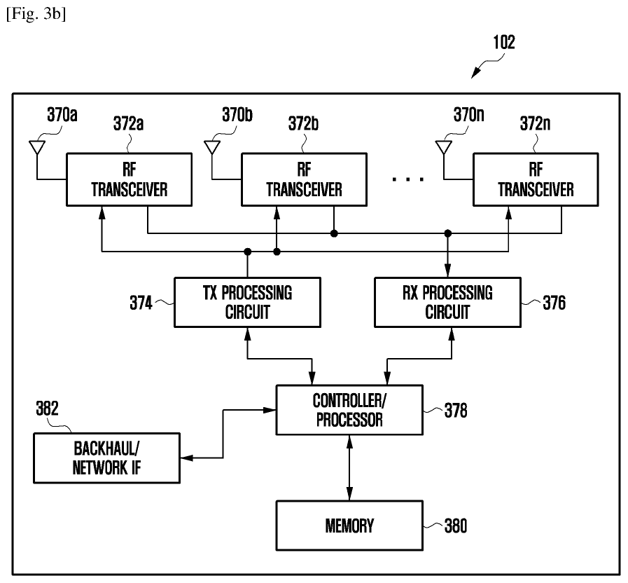

FIG. 5 illustrates a schematic diagram of the implementation effect of this scheme, by taking the full-duplex transmission mode with uplink transmission of the IAB-MT and uplink reception of the IAB-DU of the same IAB node as an example according to an embodiment of the disclosure.

A time-domain resource allocation method is characterized in that a terminal (for example, the IAB-MT) acquires an uplink minimum scheduling delay and/or a downlink minimum scheduling delay for scheduling physical transmission on a specific time-domain resource. The scheduling delay indicates the time-domain interval between the time unit where the scheduling grant information is transmitted and the time unit of scheduled physical transmission; and the physical transmission includes at least one of the following: the transmission of a physical uplink shared channel (PUSCH), a physical downlink shared channel (PDSCH), a channel state information reference signal (CSI-RS), or a sounding reference signal (SRS). Specifically, the specific time-domain resources may be time-domain resources related to full-duplex transmission, for example, time units such as time-domain symbols/slots/subframes of full-duplex transmission acquired according to the method described in Embodiment 1. This design makes the IAB-MT receive the scheduling signaling ahead of full-duplex transmission with a long enough time advance (minimum scheduling delay constraint). Reasonable selection of the minimum scheduling delay constraint can ensure that the IAB-DU of the same node has enough time to perform the physical transmission scheduling related to full-duplex transmission within the present serving cell. On this premise, the scheduling delay of physical transmission scheduling on other slot resources may not be affected. Particularly, the way for the terminal to acquire the configuration information of the uplink minimum scheduling delay and/or the downlink minimum scheduling delay is that the terminal acquires the configuration of the uplink minimum scheduling delay and/or the downlink minimum scheduling delay in a master information block (MIB), a first system information block (SIB1) or other system information blocks (SIBs). This design can make the configured uplink minimum scheduling delay be applied to all or most of uplink physical transmissions, which may include PUSCH transmissions scheduled by DCI carrying a Temporary Cell Radio Network Temporary Identifier (TC-RNTI), PUSCH transmissions carrying random access response messages, etc., and make the configured downlink minimum scheduling delay be applied to all or most of downlink physical transmissions, which may include PDSCH transmissions scheduled in the common search space associated with CORESET0, PDSCH transmissions scheduled according to SI-RNTI or RA-RNTI, etc., so as to ensure that the time when the IAB-MT receives all scheduling signaling is earlier than the time when the IAB-DU of the same node sends scheduling signaling on the time-domain resources related to full-duplex transmission.

A time-domain resource allocation method is characterized in that a terminal (for example, an IAB-MT and an access user) acquires an uplink maximum scheduling delay and/or a downlink maximum scheduling delay for scheduling physical transmission on a specific time-domain resource. Particularly, the terminal is located within the serving cell of the IAB-DU of the IAB node of the full-duplex transmission. The scheduling delay indicates the time-domain interval between the time unit where the scheduling grant information is transmitted and the time unit of scheduled physical transmission; and the meaning of the physical transmission includes at least one of the following: a physical uplink shared channel (PUSCH), a physical downlink shared channel (PDSCH), a CSI-RS, and a SRS. Specifically, the specific time-domain resource may be a time-domain resource related to full-duplex transmission, for example, time units such as time-domain symbols/slots/subframes of full-duplex transmission acquired according to the method described in Embodiment 1. Specifically, after the terminal acquires the uplink maximum scheduling delay for physical transmission on a specific time-domain resource, if the scheduling delay acquired according to the DCI of the uplink scheduling grant is greater than the uplink maximum scheduling delay, the terminal considers that the scheduling grant of the DCI is invalid. This design can be used to configure the maximum scheduling delay of the terminal within the serving cell of the IAB-DU, so that the IAB-MT of the same node can receive the scheduling signaling before the IAB-DU sends the scheduling grant information. Reasonable selection of the maximum scheduling delay constraint can ensure that the IAB-DU of the same node has enough time to perform the physical transmission scheduling related to full-duplex transmission in the present serving cell. On this premise, the scheduling delay of physical transmission scheduling on other slot resources may not be affected. Particularly, the way for the terminal to acquire the configuration information of the uplink maximum scheduling delay and/or the downlink maximum scheduling delay is that the terminal acquires the configuration of the uplink maximum scheduling delay and/or the downlink maximum scheduling delay in a master information block (MIB), a first system information block (SIB1) or other system information blocks (SIBs). This design can make the configured uplink maximum scheduling delay be applied to all or most of uplink physical transmissions, which may include PUSCH transmissions scheduled by DCI carrying a TC-RNTI, PUSCH transmissions carrying random access response messages, etc., and make the configured downlink maximum scheduling delay be applied to all or most of downlink physical transmissions, which may include PDSCH transmissions scheduled in the common search space associated with CORESET0, PDSCH transmissions scheduled according to SI-RNTI or RA-RNTI, etc., so as to ensure that the time when the IAB-MT receives all scheduling signaling is earlier than the time when the IAB-DU of the same node sends scheduling signaling on the time-domain resources related to full-duplex transmission.

A time-domain resource allocation method is characterized in that a terminal (for example, an IAB-MT) acquires scheduling delay configuration for physical transmission on a specific time-domain resource, and more specifically, the physical transmission includes uplink physical transmission and/or downlink physical transmission. Specifically, the specific time-domain resource may be a time-domain resource related to full-duplex transmission, for example, time units such as time-domain symbols/slots/subframes of full-duplex transmission acquired according to the method described in Embodiment 1. Furthermore, the specific method of acquiring the scheduling delay configuration for the physical transmission on the specific time-domain resource may be that the terminal acquires the scheduling delay offset for the uplink physical transmission and/or the downlink physical transmission of the specific time-domain resource. For example, if the terminal determines the scheduling delay k₂ according to the time-domain resource allocation indication of DCI and the PUSCH time-domain resource allocation list configured by high-layer signaling, then the scheduling delay for the PUSCH of the specific time-domain resource is k₂+Δk₂, where Δk₂ is the scheduling delay offset for the PUSCH of the specific time-domain resource; and if the terminal determines the scheduling delay k₀ according to the time-domain resource allocation indication of the DCI and the PDSCH time-domain resource allocation list configured by the high-layer signaling, then the scheduling delay for the PDSCH of the specific time-domain resource is k₀+Δk₀, where Δk₀ is the scheduling delay offset for the PDSCH of the specific time-domain resource. The advantage of this design is that there is little change to the existing scheduling delay configuration. For example, the scheduling delay offset can be given a value by the high-layer signaling and triggered by the DCI, and does not involve changes to the configuration related to time-domain resource allocation in the scheduling grant DCI and the high-layer signaling. Or, the specific method of acquiring the scheduling delay configuration for physical transmission on a specific time-domain resource can also be that the terminal acquires the PDSCH time-domain resource allocation list and/or the PUSCH time-domain resource allocation list for the specific time-domain resource, for example, the terminal acquires the PUSCH time-domain resource allocation list A and the PUSCH time-domain resource allocation list B configured by the high-layer signaling, the terminal determines the PUSCH time-domain resource allocation list as one of A and B according to the DCI indication, and the terminal determines the scheduling delay according to the determined PUSCH time-domain resource allocation list and the indication of time-domain resource allocation in the DCI. One of the PUSCH time-domain resource allocation list A and the PUSCH time-domain resource allocation list B is used for PUSCH transmission configuration on the specific time-domain resource and the other is used for PUSCH transmission configuration on other time-domain resources. The example is also applicable to PDSCH.

### Embodiment 3

In this embodiment, an invalid resource configuration and related transmission method are described, which can dynamically configure the invalid resource position of the receiving end in full-duplex transmission, thus ensuring that when the pilot signal for self-interference channel estimation sent by the transmission end of full-duplex transmission has a dynamically configured symbol position, the receiving end can acquire the invalid resource configuration of the symbol corresponding to the pilot signal. The pilot signal may be a reference signal. The meaning of invalid resources is that uplink physical channels and/or uplink physical signals are not transmitted on uplink invalid resources; and downlink physical channels and/or downlink physical signals are not transmitted on downlink invalid resources, for example, uplink invalid symbol configuration, downlink rate matching configuration, etc. in the NR protocol.

Although the current protocol supports invalid resource configuration, such as uplink invalid symbol configuration, downlink rate matching configuration, etc., the principle of all these configuration methods is to configure a resource configuration list containing a limited number of uplink invalid symbol positions/downlink rate matching patterns by a high layer, and then to instruct by DCI to enable one of the lists as an invalid resource in the current scheduling. It can be seen that the current system cannot support dynamic invalid symbol configuration.

In actual systems, it is highly possible that the pilot signal used for self-interference channel estimation has a dynamic symbol position. For example, when the demodulation reference signal is used as the pilot signal for self-interference channel estimation (the demodulation reference signal is the most suitable pilot signal for self-interference channel estimation), the symbol position of the demodulation reference signal can be dynamically configured by DCI. At this time, the invalid time-domain resource configuration corresponding to the receiving end of full-duplex transmission also needs to support the dynamic configuration mode.

An invalid resource configuration and transmission method is characterized in that a terminal receives DCI and/or high-layer signaling of scheduling grant to acquire the configuration of uplink and/or downlink invalid symbol(s) within one or more slots, in which the positions of invalid symbols within the slots containing the invalid symbols can be the same or different. Furthermore, the invalid resource configuration method may also include one of the characteristics that the terminal receives DCI for scheduling grant and acquires invalid symbol positions, and the invalid symbol positions indicated in DCI are invalid symbol positions within the first slot of the physical transmission scheduled by DCI. For example, the position of the invalid symbol within the first slot of the scheduled physical transmission indicated by 2 bits in DCI is at least one of the following indexes: #0, #2, #4, #8. The physical transmission scheduled by DCI may be PUSCH and/or PDSCH. This design can dynamically configure invalid symbol positions and ensure the flexibility of invalid symbol position configuration.

When the physical transmission scheduled by DCI is a cross-slot transmission (e.g., repeated transmission), further, the terminal acquires the position of a slot containing an invalid symbol(s) among multiple slots occupied by the scheduled physical transmission. A specific way may be that the terminal acquires high-layer configuration information and/or DCI configuration information, which is used to indicate the position of a slot containing an invalid symbol(s) among multiple slots of the scheduled physical transmission, for example, it indicates slots containing invalid symbols among N slots by N bits in a bitmap manner, in which the i-th bit is used to indicate the two states that the i-th slot contains or does not contain invalid symbols; or, if the indication of the interval between slots containing invalid symbols acquired by the terminal is M, from the first slot among multiple slots of the scheduled physical transmission, an invalid symbol is contained in every M slots (including the first slot), and the remaining slots do not contain invalid symbols. Or, the terminal acquires the position of a slot containing an invalid symbol among multiple slots occupied by the scheduled physical transmission, and the specific way can also be that the terminal acquires the preset positions of slots containing invalid symbols, for example, except the first slot of the physical transmission, the remaining slots of the scheduled physical transmission do not contain invalid symbols; or, all slots of the scheduled physical transmission contain invalid symbols, etc. This design takes the time-varying characteristics of self-interference channel estimation into consideration. If the self-interference channel is a slow-varying channel, it is not necessary to estimate the self-interference channel in every slot. In this way, the necessary and non-redundant invalid resources can be configured to ensure the efficiency of resource utilization. Furthermore, the terminal also needs to acquire the position of an invalid symbol in the slot containing the invalid symbol(s), and a specific way may be that the terminal acquires the position of an invalid symbol within the first slot of the scheduled physical transmission (for example, acquires it by receiving DCI for scheduling grant), and position configuration of the invalid symbol within the first slot is applicable to the remaining other slots containing invalid symbols. Or, the terminal also needs to acquire the position of an invalid symbol in the slot containing the invalid symbol, and a specific way can also be that, except the first slot, the starting positions of invalid symbols within the remaining slots containing the invalid symbols among multiple slots of scheduled physical transmission are the first symbols within the slots. Furthermore, the terminal can acquire the indication information in DCI or high-layer signaling, which is used to indicate that the way for the terminal to acquire the position of the invalid symbol in the slot containing the invalid symbol(s) is one of the above two methods. The two designs of invalid symbol positions in multiple slots are designed by considering the symbol positions of demodulation reference signals in different slots under PUSCH rep type A and PUSCH rep type B.

An invalid resource configuration and transmission method is characterized in that a terminal acquires a user group DCI for determining uplink and/or downlink invalid symbols within one or more slots, and applies the configuration of uplink and/or downlink invalid symbol(s) on specific physical resources as follows. The specific physical resources include at least one of physical resources related to first duplex transmission and physical resources related to first duplex transmission in a specific transmission direction which includes uplink and/or downlink. The multiple slots can be continuous or discontinuous slots. For example, the terminal determines whether invalid symbols are contained or not and determines multiple slots for positions of the invalid symbols according to the user group DCI, the multiple slots may be multiple discontinuous slots related to full-duplex transmission, and the terminal may acquire the positions of slots related to full-duplex transmission according to the method in Embodiment 1. The advantage of this design is that the dynamic cell-level configuration of invalid symbols can be realized by indicating invalid symbols through the user group DCI. More specifically, the terminal can acquire indication indicating whether a specific DCI format is used to indicate invalid symbols. For example, the terminal acquires high-layer signaling indicating DCI format 2_4 is used to indicate uplink invalid symbols or is used to indicate time-frequency resources where uplink transmission is cancelled (existing function of DCI format 2_4). After receiving DCI format 2_4, the terminal can parse DCI format 2_4 according to the purpose indicated by the high-layer signaling.

An invalid resource configuration and transmission method is characterized in that when a terminal acquires the uplink invalid symbol configuration and the uplink invalid symbols overlap with the physical resources of the terminal uplink transmission, the related behaviors of the terminal uplink transmission include at least one of the following: PUSCH transmission does not perform rate matching on the physical resources corresponding to the uplink invalid symbols; the PUCCH format 3 transmission does not perform rate matching on the physical resources corresponding to the uplink invalid symbols; PUCCH format 0/format 1/format 2/format 4 transmission is cancelled; SRS transmission is cancelled or postponed until after the uplink invalid symbols. In view of the transmission characteristics of different uplink physical channels and physical signals, the related transmission modes of invalid symbols are specially designed respectively. For example, the PUCCH format 0/format 1/format 2/format 4 needs time-domain spread spectrum, and appearance of invalid symbols will lead to the failure of PUCCH transmission, so it is best to cancel the transmission.

An invalid resource configuration and transmission method is characterized in that after acquiring the configuration of a downlink rate matching pattern(s) for downlink transmission, a terminal (for example, an IAB-MT) applies the configuration of the downlink rate matching pattern(s) on specific physical resources, which may be physical resources related to full-duplex transmission or physical resources related to a specific full-duplex transmission direction, for example, the full-duplex transmission slots determined according to the method in Embodiment 1, the slots of reception by the IAB-MT and transmission by the IAB-DU of the same node, etc. The specific full-duplex transmission direction includes an uplink transmission direction or a downlink transmission direction. The advantage of this design is that when the configured rate matching of the downlink transmission is for the purpose of full-duplex transmission, the downlink rate matching configuration is applied only on full-duplex transmission slots, and the downlink rate matching configuration does not need to be applied to non-full-duplex transmission slots, thus ensuring the utilization efficiency of physical resources on the non-full-duplex transmission slots.

An invalid resource configuration and transmission method is characterized in that when a terminal (for example, an IAB-MT) acquires a downlink rate matching configuration, a base station (for example, an IAB-DU) of the same communication node determines physical resources of downlink reference signals on specific physical resources according to the downlink rate matching configuration acquired by the terminal (for example, the IAB-MT). The specific downlink reference signal(s) includes at least one of the following: a downlink demodulation reference signal, a channel state information reference signal (CSI-RS), and a downlink reference signal related to the first duplex transmission. Specifically, the specific physical resources may be physical resources related to full-duplex transmission or physical resources related to a specific full-duplex transmission direction, for example, full-duplex transmission slots determined according to the method in Embodiment 1, the slots of reception by the IAB-MT and transmission by the IAB-DU of the same node, etc., Or, An invalid resource configuration and transmission method is characterized in that when a terminal (for example, an IAB-MT) acquires a rate matching pattern indication of downlink transmission and the downlink rate matching is the configuration for full-duplex transmission, a base station (for example, an IAB-DU) of the same communication node determines physical resources of downlink pilots on specific physical resources according to the downlink rate matching pattern indication acquired by the terminal (for example, the IAB-MT). Or, an invalid resource configuration and transmission method is characterized in that when a terminal (e.g., an IAB-MT) acquires a rate matching pattern indication of downlink transmission and the downlink rate matching is the downlink pilot physical resource configuration of a base station (e.g., an IAB-DU) of the same communication node, the base station (e.g., the IAB-DU) of the same communication node determines physical resources of the downlink pilots on specific physical resources according to the downlink rate matching pattern indication acquired by the terminal (e.g., the IAB-MT). In the above various methods, more specifically, the specific way for the base station to determine the physical resources of downlink pilots on specific physical resources according to the downlink rate matching pattern indication acquired by the terminal of the same node may be that the IAB-DU determines the physical resources of downlink pilots on full-duplex transmission slots according to the downlink rate matching pattern(s) acquired by the IAB-MT of the same node, and the physical resources indicated by the downlink rate matching pattern(s) are taken as the physical resources of downlink pilots. This design can ensure that the downlink pilot will not overlap with the downlink reception of the IAB-MT, thus ensuring the performance of self-interference channel estimation.

### Embodiment 4

In this embodiment, a transmission configuration method is described, which can be used for an IAB parent node to configure the configuration information related to full-duplex transmission to an IAB child node, so as to ensure the self-interference cancellation performance of the IAB child node during full-duplex transmission.

A transmission configuration method is characterized in that a node IAB-DU is provided with the configuration of a reference signal(s) related to full-duplex transmission, which can be a specific downlink reference signal(s) sent by the IAB-DU or a specific uplink reference signal(s) sent by an IAB-MT of the same node. The specific downlink reference signal(s) includes at least one of a downlink demodulation reference signal, a channel state information reference signal and a downlink reference signal related to full-duplex transmission; and the specific uplink reference signal(s) includes at least one of an uplink demodulation reference signal, a sounding reference signal and an uplink reference signal related to full-duplex transmission. Specifically, when the configuration of the reference signal related to full-duplex transmission provided for the node IAB-DU is the uplink reference signal configuration sent by the IAB-MT of the same node, the IAB-DU determines the physical resource where the IAB-MT sends the uplink reference signal according to the reference signal configuration, and configures the corresponding resource as an invalid resource, and the terminal within the cell of the IAB-DU acquires the uplink invalid resource configuration and performs transmission. The specific method can be as in Embodiment 3. With this design, the IAB-DU can obtain the reference signal configuration parameters of the parent node, and the IAB-DU performs transmission of reference signals or configuration of invalid resources related to full-duplex transmission according to the configuration of the parent node, thus ensuring the self-interference cancellation performance of the IAB node. Furthermore, the signaling by which the node IBA-DU is provided with the reference signal configuration may be the configuration signaling received by the IAB-MT of the same node, and involves at least one of the following: high-layer signaling, scheduling grant DCI, and user group DCI. And, the specific configuration of the reference signal related to full-duplex transmission includes at least one of the following: reference signal type, reference signal port, reference signal frequency-domain mapping offset, reference signal mapping time-domain symbol, reference signal mapping starting time-domain symbol and reference signal bandwidth. The reference signal type may include types affecting the frequency-domain mapping mode of the reference signal, such as demodulation reference signal type 1, demodulation reference signal type 2, or types mapped on the same time-domain symbol with a frequency-domain density of 4 resource particles (that is, every 3 resource particles), etc. The reference signal frequency-domain mapping offset refers to the index offset of the starting subcarrier to which the reference signal is mapped.

A transmission configuration method is characterized in that a node IAB-DU is provided with information for configuring an uplink invalid symbol or uplink invalid resource pattern of the cell of the IAB-DU. Preferably, the invalid resource(s) is the physical resource used by the corresponding IAB-MT of the same node to send an uplink reference signal. This design enables the IAB-DU to know the configuration and scheduling parameters of the parent node for the IAB-MT of the same node according to the invalid resource configuration, which can then be used for the IAB node to perform the self-interference channel estimation, thus ensuring the performance of self-interference cancellation. Preferably, the node IAB-DU may configure the invalid resources of the terminal within its cell according to the provided invalid resource configuration. The method for acquiring the invalid resource configuration by the terminal within the cell may be as various methods in Embodiment 3. Furthermore, the signaling by which the node IAB-DU is provided with the invalid resource configuration may be the configuration signaling received by the IAB-MT of the same node, and involves at least one of the following: high-layer signaling, scheduling grant DCI, and user group DCI. And, the specific configuration of the invalid resource configuration provided for the node IAB-DU includes at least one of the following: the time-domain symbol of the invalid resource, the bandwidth of the invalid resource, the starting subcarrier of the invalid resource(s) and the resource pattern of the invalid resource(s). The resource pattern(s) of the invalid resource(s) is used to indicate the position of a resource particle belonging to the invalid resource(s) on one or more physical resource blocks within one or more time-domain symbols. For example, a possible resource pattern(s) of the invalid resource(s) may indicate that an invalid resource particle appears every three resource particles in the frequency domain on one or more time-domain symbols.

A transmission configuration method is characterized in that a communication node acquires a full-duplex transmission indication which indicates whether to enable full-duplex resource allocation of the communication node. When the communication node is a terminal (including an IAB-MT), the terminal acquiring the full-duplex transmission indication may be the terminal acquiring the full-duplex transmission in-dication configured by the high-layer signaling, the scheduling grant DCI and the user group DCI. When the communication node is an IAB-DU, the IAB-DU is provided with a full-duplex indication for indicating whether to enable full-duplex resource allocation within the cell of the IAB-DU, and the method for the IAB-DU to acquire the full-duplex indication may be that the IAB-MT of the same node receives at least one of the following to obtain full-duplex indication signaling: high-layer signaling, scheduling grant DCI and user group DCI. This design can make the parent node choose to enable or disable the full-duplex resource allocation of the child node according to the network deployment situation, thus reducing the inter-cell interference between IAB nodes.

Specifically, when the full-duplex transmission indication acquired by either the IAB-DU or the IAB-MT of the same node is “yes”, the communication node IAB can assume that when the IAB-DU schedules downlink transmission, the IAB-MT of the same node also performs downlink transmission; or when the IAB-DU schedules uplink transmission, the IAB-MT of the same node also performs uplink transmission. And, specifically, after acquiring the full-duplex transmission indication, the communication node can determine the parsing mode of the DCI according to the full-duplex transmission indication, for example, determine various indication fields in the DCI. A specific implementation is that the communication node acquires at least one of the following items to determine the full-duplex transmission indication of the communication node: high-layer signaling, scheduling grant DCI and user group DCI. Another specific implementation is that the communication node determines whether the current physical transmission is a physical transmission related to full-duplex transmission according to the physical resource configuration related to full-duplex transmission and the resource allocation of physical transmission. The physical resource configuration related to full-duplex transmission may be time-domain and/or frequency-domain resources related to full-duplex transmission, such as symbols, slots, subframes and radio frames related to full-duplex transmission acquired according to the method in Embodiment 1, and/or bandwidth and bandwidth parts related to full-duplex transmission. Specifically, the specific meaning of the current physical transmission of a communication node being physical transmission related to full-duplex transmission includes that the current physical transmission of the communication node is at least one of the physical transmission sent and the physical transmission received by the same node in full-duplex transmission. And, specifically, the specific way for the communication node to determine whether the current physical transmission is physical transmission related to full-duplex transmission or not can be as follows: if the resource allocation of the current physical transmission is in the physical resource configuration related to full-duplex transmission, the communication node determines that the current physical transmission is physical transmission related to full-duplex transmission; otherwise, the current physical transmission is not physical transmission related to full-duplex transmission. Furthermore, when the IAB node acquires the full-duplex transmission indication or determines that the current physical transmission is physical transmission related to full-duplex transmission, the operation of the IAB node may include at least one of the following: the IAB-MT acquires the downlink invalid resource configuration and determines the downlink transmission method (for example, the method in Embodiment 3); the IAB-DU configures the uplink invalid resource(s) and the terminal in the cell of the IAB-DU acquires the uplink invalid resource configuration and determines the downlink transmission method (for example, the method in Embodiment 3).

### Embodiment 5

In this embodiment, a signaling reporting method is described, which can be used for an IAB child node to report configuration and/or scheduling information related to full-duplex transmission to its parent node, so as to ensure the self-interference cancellation performance of the IAB child node during full-duplex transmission.

A signaling reporting method is characterized in that an IAB node reports a full-duplex transmission related request which can be a scheduling request for full-duplex transmission. Specifically, the full-duplex scheduling request may be for at least one of the following full-duplex transmission cases: a full-duplex transmission request that the IAB-DU receives and transmits signals at the same time, a request that the IAB-DU performs downlink transmission on the physical resource where the IAB-MT performs downlink reception or may perform downlink reception, and a request that the IAB-DU performs uplink reception on the physical resource where the IAB-MT performs uplink transmission or may perform uplink transmission. Specifically, the number of scheduling requests for full-duplex transmission reported by the IAB node may be one or more, and different full-duplex scheduling requests correspond to scheduling requests of different full-duplex transmission situations respectively. This implementation enables the IAB node to dynamically report the full-duplex scheduling request in real time with less signaling overhead. After receiving the full-duplex scheduling request of the child node, the parent node can perform related scheduling or resource configuration, such as the invalid resource configuration in Embodiment 3, to ensure the self-interference cancellation performance of the child node IAB during full-duplex transmission. More specifically, the method for the IAB node to report the full-duplex transmission related request may be that the IAB-MT sends an uplink control channel or an uplink shared channel carrying the full-duplex transmission related request. The specific way to report the full-duplex transmission related request by using the uplink control channel may be that the information bits of the full-duplex transmission related request and the hybrid automatic repeat request acknowledgement message (HARQ-ACK) are mixed-coded or mixed-modulated and reported together. In addition to reporting the full-duplex transmission related request, the IAB node can also report the time-domain and/or frequency-domain physical resources scheduled for full-duplex transmission, such as time-domain symbols/slots/subframes where the full-duplex transmission is expected to be performed, and/or physical resource block positions where the full-duplex transmission is expected to be performed. Or, there is a fixed relationship between the time-domain symbol/slot/subframe where the IAB node is expected to perform the full-duplex transmissione and the time-domain symbol/slot/subframe where the full-duplex transmission related request is reported. For example, if the slot in which the full-duplex transmission related request is reported is n, the slot in which the IAB node is expected to perform the full-duplex transmission is n+N, where N is a fixed value.

A signaling reporting method is characterized in that an IAB node reports full-duplex transmission related configuration which can be the configuration of a reference signal related to full-duplex transmission or invalid resource configuration related to full-duplex transmission. Specifically, the reference signal related to full-duplex transmission may be a downlink reference signal sent by the IAB-DU and/or an uplink reference signal received by the IAB-DU. Specifically, the invalid resource configuration related to full-duplex transmission may be the uplink and/or downlink invalid resource configuration configured by the IAB-DU and received by the terminal within the cell of the IAB-DU, for example, the uplink invalid symbol configuration, the downlink rate matching configuration, and so on. And, preferably, the reference signal(s) may be an uplink demodulation reference signal(s) or a downlink demodulation reference signal(s). This design enables the parent node to obtain the configuration parameters related to full-duplex transmission of the child node IAB-DU, and to perform transmission of reference signals or invalid resource configuration related to full-duplex transmission according to the reported configuration, thus ensuring the self-interference cancellation performance of the IAB child node. More specifically, the method for the IAB node to report the full-duplex transmission related configuration may be that the IAB-MT sends an uplink control channel or an uplink shared channel carrying the full-duplex transmission related configuration. And, the content of the configuration of the reference signal related to full-duplex transmission reported by the IAB node can include at least one of the following: reference signal type, reference signal port, reference signal frequency-domain mapping offset, reference signal mapping time-domain symbol, reference signal mapping starting time-domain symbol and reference signal bandwidth. The reference signal type may include types affecting the frequency-domain mapping mode of the reference signal, such as demodulation reference signal type 1, demodulation reference signal type 2, or types mapped on the same time-domain symbol with a frequency-domain density of 4 resource particles (that is, every 3 resource particles), etc. The reference signal frequency-domain mapping offset refers to the index offset of the starting subcarrier to which the reference signal is mapped. And, the content of invalid resource configuration related to full-duplex transmission reported by the IAB node may include at least one of the following: the time-domain symbol(s) of the invalid resource(s), the bandwidth of the invalid resource(s), the starting subcarrier of the invalid resource(s) and the resource pattern(s) of the invalid resource(s). The resource pattern(s) of the invalid resource(s) is used to indicate the position of a resource particle belonging to the invalid resource on one or more physical resource blocks within one or more time-domain symbols. For example, a possible resource pattern(s) of the invalid resource(s) may indicate that an invalid resource particle appears every three resource particles in frequency domain on one or more time-domain symbols.

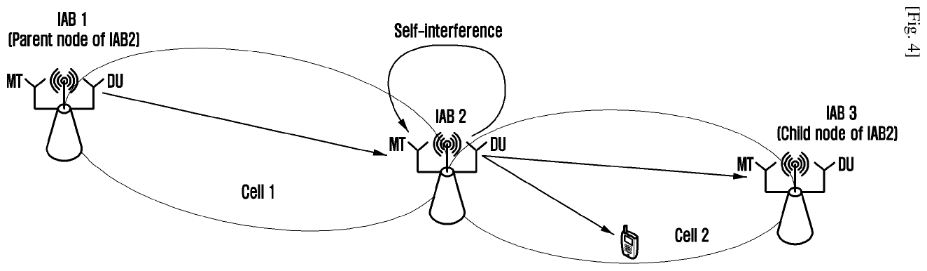

FIG. 6 illustrates a flow chart of a signal transmission method according to an embodiment of the disclosure. The method includes: in step 601, a first node acquires a physical resource related to a first duplex transmission from a second node; and in step 602, the first node performs uplink transmission and/or downlink transmission with the second node according to the acquired physical resource related to the first duplex transmission. The physical resource related to the first duplex transmission includes time-domain and/or frequency-domain resources for performing the first duplex transmission or time-domain and/or frequency-domain resources possible for performing the first duplex transmission.

Acquiring the physical resource related to the first duplex transmission is at least based on at least one of the following items: time division duplex (TDD) uplink and downlink configuration, resource validation configuration, and the first duplex capability of a communication node.

The first node is a base station. In various embodiments, the base station may include at least one of an eNB, a gNB or a distributed unit (IAB-DU) of an IAB node, or the first node is a terminal. In various embodiments, the terminal may include at least one of a mobile phone terminal, a computer terminal, or a mobile terminal (IAB-MT) of an IAB node.

The first node is an IAB node, and the mobile terminal (MT) of the IAB node acquires a first duplex slot pattern A of a serving cell A where it is located, and the distributed unit (DU) of the IAB node acquires a first duplex slot pattern B of its serving cell B, and the first duplex slot pattern A and the first duplex slot pattern B indicate the first duplex slot pattern in the same transmission direction or respectively indicate the first duplex slot patterns in different transmission directions, and the transmission direction includes uplink and/or downlink.

The first node is an IAB node, and when the DU of the IAB node acquires TDD uplink and downlink configuration, it applies the acquired TDD uplink and downlink configuration to configure the TDD uplink and downlink configuration within its serving cell; or when the DU of the IAB node acquires the TDD uplink and downlink configuration, if the TDD uplink and downlink configuration configured for its serving cell is different from the acquired TDD uplink and downlink configuration, it reports a TDD uplink and downlink configuration conflict message to its IAB parent node.

The method further includes acquiring by the first node information which may include at least one of the following: an uplink minimum scheduling delay and/or a downlink minimum scheduling delay for scheduling physical transmission on a specific time-domain resource, an uplink maximum scheduling delay and/or a downlink maximum scheduling delay for scheduling physical transmission on a specific time-domain resource, or the scheduling delay configuration for uplink physical transmission and/or downlink physical transmission of a specific time-domain resource, and the specific time-domain resource is a time-domain resource related to the first duplex transmission, and the scheduling delay indicates a time-domain interval between a time unit where scheduling grant information is transmitted and a time unit of scheduled physical transmission, and the physical transmission may include transmission of at least one of a physical uplink shared channel (PUSCH), a physical downlink shared channel (PDSCH), a channel state information reference signal (CSI-RS), or a sounding reference signal (SRS).

Acquiring the uplink minimum scheduling delay and/or the downlink minimum scheduling delay for scheduling the physical transmission on the specific time-domain resource includes acquiring the configuration of the uplink minimum scheduling delay and/or the downlink minimum scheduling delay in a master message block (MIB), a first system message block (SIB1) or other system message blocks (SIBs).

Acquiring the uplink maximum scheduling delay and/or the downlink maximum scheduling delay for scheduling the physical transmission on the specific time-domain resource includes acquiring the configuration of the uplink maximum scheduling delay and/or the downlink maximum scheduling delay in a master message block (MIB), a first system message block (SIB1) or other system message blocks (SIBs).

After the first node acquires the uplink maximum scheduling delay for scheduling the physical transmission on the specific time-domain resource, if the scheduling delay acquired according to the downlink control information (DCI) of the uplink scheduling grant is greater than the uplink maximum scheduling delay, the scheduling grant of the DCI is considered invalid.

Acquiring by the first node the scheduling delay configuration for the physical transmission on the specific time-domain resource is implemented by acquiring at least one of the following: acquiring scheduling delay offset of uplink physical transmission and/or downlink physical transmission of the specific time-domain resource; and acquiring a physical downlink shared channel (PDSCH) time-domain resource allocation list and/or a physical uplink shared channel (PUSCH) time-domain resource allocation list for the specific time-domain resource.

The method also includes that the first node receives DCI and/or high-layer signaling of the scheduling grant and acquires the configuration of uplink and/or downlink invalid symbol(s) within one or more slots.

After acquiring the configuration of a downlink rate matching pattern(s) for downlink transmission, the first node applies the configuration of downlink rate matching on a specific physical resource which includes the physical resource related to the first duplex transmission or the physical resource related to the first duplex transmission in a specific transmission direction, the specific transmission direction being downlink.

The method also includes that the first node acquires a user group DCI for determining uplink and/or downlink invalid symbols within one or more slots and applies the configuration of uplink and/or downlink invalid symbol(s) on the specific physical resource including at least one of the physical resource related to the first duplex transmission and the physical resource related to the first duplex transmission in the specific transmission direction which includes uplink and/or downlink.

The method also includes: when the first node acquires the uplink invalid symbol configuration and the uplink invalid symbols overlap with physical resources of the uplink transmission of the first node, behaviors related to the uplink transmission of the first node include at least one of the following: the PUSCH transmission does not perform rate matching on the physical resources corresponding to the uplink invalid symbols; the PUCCH format 3 transmission does not perform rate matching on the physical resources corresponding to the uplink invalid symbols; the PUCCH format 0/format 1/format 2/format 4 transmission is cancelled; the SRS transmission is cancelled or postponed until after the uplink invalid symbols.

The first node is a terminal. In various embodiments, the terminal may include at least one of a mobile phone terminal, a computer terminal, or a mobile terminal (IAB-MT) of an IAB node.

The first node is an IAB node, and the IAB node includes an MT and a DU.

The method further includes: when the MT of the IAB node acquires the rate matching pattern indication configured for downlink transmission on a specific physical resource, the DU of the IAB node determines the physical resource of a specific downlink reference signal on the specific physical resource according to the downlink rate matching pattern indication acquired by the MT of the IAB node. The specific downlink reference signal(s) includes at least one of a downlink demodulation reference signal, a channel state information reference signal and a downlink reference signal related to the first duplex transmission. And, the downlink rate matching in-dication acquired by the IAB node can be one of the following: a downlink rate matching indication configured for a specific physical resource, a downlink rate matching indication used for the first duplex transmission, and a downlink pilot physical resource configuration used for the DU of the same communication node. And/or, the method further includes: when the IAB node acquires the rate matching pattern indication of downlink transmission and the downlink rate matching is the downlink pilot physical resource configuration for the DU of the IAB node, the IAB node determines the physical resource of the downlink pilot on the specific physical resource according to the acquired downlink rate matching pattern indication.

An uplink minimum scheduling delay and/or a downlink minimum scheduling delay for scheduling physical transmission on a specific time-domain resource are acquired by the MT of the IAB node, while an uplink maximum scheduling delay and/or a downlink maximum scheduling delay for scheduling physical transmission on a specific time-domain resource are acquired by the DU of the IAB node.

The DU of the IAB node is provided with the configuration of a specific reference signal(s) including a specific downlink reference signal(s) sent by the DU of the IAB node or a specific uplink reference signal(s) sent by the MT of the IAB node.

The specific downlink reference signal(s) includes at least one of a downlink demodulation reference signal, a channel state information reference signal and a downlink reference signal related to the first duplex transmission; and the specific uplink reference signal(s) includes at least one of an uplink demodulation reference signal, a sounding reference signal and an uplink reference signal related to the first duplex transmission.

The DU of the JAB node configures uplink invalid symbols or uplink invalid resource particle positions for terminals within the cell according to the uplink reference signal configuration of the MT of the JAB node.

The DU of the JAB node is provided with information for configuring uplink invalid symbols or uplink invalid resource patterns of the cell of the DU of the JAB node.

The JAB node acquires a first duplex transmission indication, and the first duplex transmission indication indicates whether to enable the first duplex resource allocation of the JAB node.

The method further includes reporting a request related to the first duplex transmission which includes scheduling request a first duplex transmission, and the scheduling request for first duplex transmission is for at least one of the following first duplex transmission cases: a first duplex transmission request that the DU of the JAB node receives and transmits signals at the same time, a request that the DU of the JAB node performs downlink transmission on the physical resource where the MT of the JAB node performs downlink reception or possibly performs downlink reception, and a request that the DU of the JAB node performs uplink reception on the physical resource where the MT of the JAB node performs uplink transmission or possibly performs uplink transmission.

Reporting by the JAB node the request related to the first duplex transmission includes transmitting by the MT of the JAB node an uplink control channel or an uplink shared channel carrying the request related to the first duplex transmission.

The method further includes reporting by the first node configuration related to the first duplex transmission which includes the configuration of a reference signal(s) or the configuration of an invalid resource(s).

The reference signal(s) includes an uplink demodulation reference signal(s) or a downlink demodulation reference signal(s).

According to an aspect of the disclosure, there is provided a terminal in a wireless communication system, including: a transceiver; and a processor configured to control the transceiver to execute the method as described above.

According to an aspect of the disclosure, there is provided a base station in a wireless communication system, including: a transceiver; and a processor configured to control the transceiver to execute the method as described above.

According to an aspect of the disclosure, there is provided an JAB node, including: an MT; and a DU, and the JAB node is configured to execute the method as described above.

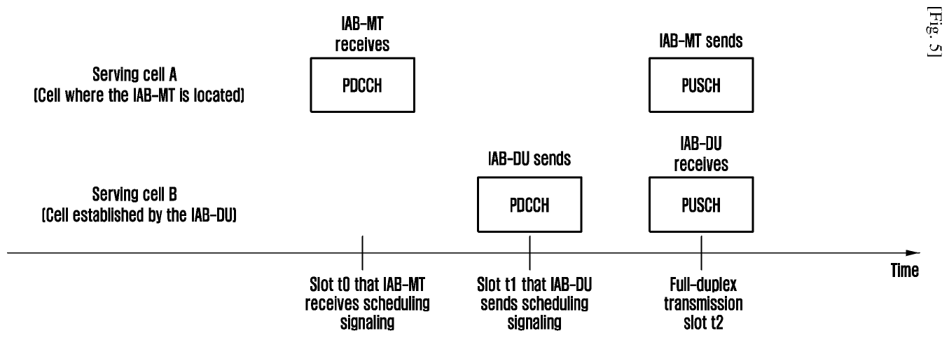

FIG. 7 illustrates a structure of a user equipment (UE) according to an embodiment of the disclosure.

Referring to FIG. 7, the UE 700 may include a controller 710, a transceiver 720, and a memory 730. However, all of the illustrated components are not essential. The UE 700 may be implemented by more or less components than those illustrated in FIG. 7. In addition, the controller 710 and the transceiver 720 and the memory 730 may be implemented as a single chip according to another embodiment.

The UE 700 may correspond to the UE described above. For example, the UE 700 may correspond to the UE in FIG. 3a.

The aforementioned components will now be described in detail.

The controller 710 may include one or more processors or other processing devices that control the proposed function, process, and/or method. Operation of the UE 700 may be implemented by the controller 710.

The transceiver 720 may include an RF transmitter for up-converting and amplifying a transmitted signal, and an RF receiver for down-converting a frequency of a received signal. However, according to another embodiment, the transceiver 720 may be implemented by more or less components than those illustrated in components.

The transceiver 720 may be connected to the controller 710 and transmit and/or receive a signal. The signal may include control information and data. In addition, the transceiver 720 may receive the signal through a wireless channel and output the signal to the controller 710. The transceiver 720 may transmit a signal output from the controller 710 through the wireless channel.

The memory 730 may store the control information or the data included in a signal obtained by the UE 700. The memory 730 may be connected to the controller 720 and store at least one instruction or a protocol or a parameter for the proposed function, process, and/or method. The memory 730 may include read-only memory (ROM) and/or random access memory (RAM) and/or hard disk and/or CD-ROM and/or DVD and/or other storage devices.

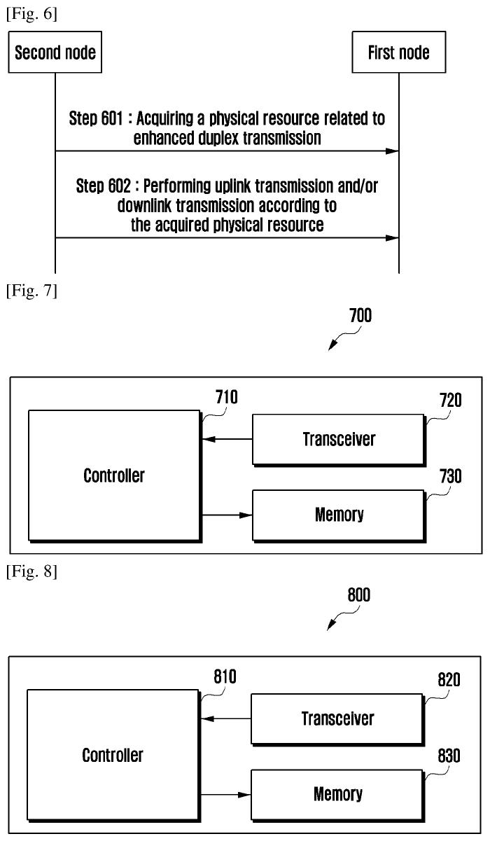

FIG. 8 illustrates a structure of a base station according to an embodiment of the disclosure.

Referring to FIG. 8, the base station 800 may include a controller 810, a transceiver 820, and a memory 830. However, all of the illustrated components are not essential. The base station 800 may be implemented by more or less components than those illustrated in FIG. 8. In addition, the controller 810 and the transceiver 820 and the memory 830 may be implemented as a single chip according to another embodiment.

The base station 800 may correspond to the gNB described in the disclosure. For example, the base station 800 may correspond to the gNB in FIG. 3b.

The aforementioned components will now be described in detail.

The controller 810 may include one or more processors or other processing devices that control the proposed function, process, and/or method. Operation of the base station 800 may be implemented by the controller 810.

The transceiver 820 may include an RF transmitter for up-converting and amplifying a transmitted signal, and an RF receiver for down-converting a frequency of a received signal. However, according to another embodiment, the transceiver 820 may be implemented by more or less components than those illustrated in components.

The transceiver 820 may be connected to the controller 810 and transmit and/or receive a signal. The signal may include control information and data. In addition, the transceiver 820 may receive the signal through a wireless channel and output the signal to the controller 810. The transceiver 820 may transmit a signal output from the controller 810 through the wireless channel.

The memory 830 may store the control information or the data included in a signal obtained by the base station 800. The memory 830 may be connected to the controller 810 and store at least one instruction or a protocol or a parameter for the proposed function, process, and/or method. The memory 830 may include read-only memory (ROM) and/or random access memory (RAM) and/or hard disk and/or CD-ROM and/or DVD and/or other storage devices.

The above flowcharts illustrate example methods that can be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the disclosure has been described with exemplary embodiments, various changes and modifications may be suggested to one skilled in the art. It is intended that the disclosure encompass such changes and modifications as fall within the scope of the appended claims. None of the description in this application should be read as implying that any particular element, step, or function is an essential element that must be included in the claims scope. The scope of patented subject matter is defined by the claims.

1. A method performed by a first node in a communication system, comprising:
obtaining a physical resource related to a first duplex transmission; and
performing uplink transmission or downlink transmission based on the obtained physical resource related to the first duplex transmission.

2. The method of claim 1,
wherein the physical resource related to the first duplex transmission includes time-domain or frequency-domain resources for performing the first duplex transmission, or time-domain or frequency-domain resources possible for performing the first duplex transmission,
wherein acquiring the physical resource related to the first duplex transmission is based on at least one of:
time division duplex (TDD) uplink and downlink configuration;
resource validation configuration; or
a first duplex capability of a communication node.

3. The method of claim 1,
wherein the first node is one of:
a base station;
a terminal; or
an integrated access and backhaul (IAB) node including a mobile terminal (MT) and a distributed unit (DU).

4. The method of claim 3,
wherein the mobile terminal (MT) of the IAB node acquires a first duplex slot pattern A of a serving cell A where it is located, and the distributed unit (DU) of the IAB node acquires a first duplex slot pattern B of its serving cell B,
wherein the first duplex slot pattern A and the first duplex slot pattern B indicate the first duplex slot pattern in the same transmission direction or respectively indicate the first duplex slot patterns in different transmission directions, and
wherein the transmission direction includes uplink and/or downlink.

5. The method of claim 1, further comprising:
obtaining information including at least one of an uplink minimum scheduling delay and/or a downlink minimum scheduling delay for scheduling physical transmission on a specific time-domain resource, an uplink maximum scheduling delay and/or a downlink maximum scheduling delay for scheduling physical transmission on a specific time-domain resource, or the scheduling delay configuration for uplink physical transmission and/or downlink physical transmission of a specific time-domain resource,
wherein the specific time-domain resource is a time-domain resource related to the first duplex transmission,
wherein the scheduling delay indicates the time-domain interval between the time unit where the scheduling grant information is transmitted and the time unit of scheduled physical transmission, and wherein the physical transmission includes transmission of at least one of the following: a physical uplink shared channel (PUSCH), a physical downlink shared channel (PDSCH), a channel state information reference signal (CSI-RS), or a sounding reference signal (SRS).

6. The method of claim 1, further comprising:
receiving downlink control information (DCI) and/or high-layer signaling of the scheduling grant; and
obtaining the configuration of uplink and/or downlink invalid symbol(s) within one or more slots,
wherein after obtaining the configuration of downlink rate matching pattern(s) for downlink transmission, the first node applies the configuration of downlink rate matching on a specific physical resource which includes the physical resource related to the first duplex transmission or the physical resource related to the first duplex transmission in a specific transmission direction, wherein the specific transmission direction is downlink.

7. The method of claim 6, further comprising:
obtaining a user group downlink control information (DCI) for determining uplink and/or downlink invalid symbol(s) within one or more slots and applying the configuration of uplink and/or downlink invalid symbol(s) on the specific physical resource including at least one of the physical resource related to the first duplex transmission and the physical resource related to the first duplex transmission in the specific transmission direction, wherein the specific transmission direction includes uplink and/or downlink,
wherein, in case that the first node is an integrated access and backhaul (IAB) node including a mobile terminal (MT) and a distributed unit (DU), an uplink minimum scheduling delay and/or a downlink minimum scheduling delay for scheduling physical transmission on a specific time-domain resource are acquired by the MT of the IAB node, while an uplink maximum scheduling delay and/or a downlink maximum scheduling delay for scheduling physical transmission on a specific time-domain resource are acquired by the DU of the IAB node, wherein the DU of the IAB node is provided with the configuration of specific reference signal(s), the specific reference signal(s) includes specific downlink reference signal(s) sent by the DU of the IAB node or specific uplink reference signal(s) sent by the MT of the IAB node, and
wherein the specific downlink reference signal(s) include at least one of a downlink demodulation reference signal, a channel state information reference signal (CSI-RS) and a downlink reference signal related to the first duplex transmission; and the specific uplink reference signal(s) include at least one of an uplink demodulation reference signal, a sounding reference signal and an uplink reference signal related to the first duplex transmission.

8. The method of claim 1, further comprising:
reporting a request related to the first duplex transmission which includes scheduling request for a first duplex transmission, and wherein the first node is an integrated access and backhaul (IAB) node including a mobile terminal (MT) and a distributed unit (DU), wherein the scheduling request for first duplex transmission is for at least one of the following first duplex transmission cases: a first duplex transmission request that the DU of the IAB node receives and transmits signals at the same time, a request that the DU of the IAB node performs downlink transmission on the physical resource where the MT of the IAB node performs downlink reception or possibly performs downlink reception, and a request that the DU of the IAB node performs uplink reception on the physical resource where the MT of the IAB node performs uplink transmission or possibly performs uplink transmission,
wherein configuration related to the first duplex transmission which includes the configuration of reference signal(s) or the configuration of invalid resource(s), is reported by the first node, and
wherein the reference signal(s) include uplink demodulation reference signal(s) or downlink demodulation reference signal(s).

9. A first node in a communication system, the first node comprising:
a transceiver; and
a controller configured to:
obtain a physical resource related to a first duplex transmission, and perform uplink transmission or downlink transmission via the transceiver based on the obtained physical resource related to the first duplex transmission.

10. The first node of claim 9,
wherein the physical resource related to the first duplex transmission includes time-domain or frequency-domain resources for performing the first duplex transmission, or time-domain or frequency-domain resources possible for performing the first duplex transmission,
wherein acquiring the physical resource related to the first duplex transmission is based on at least one of:
time division duplex (TDD) uplink and downlink configuration;
resource validation configuration; or
a first duplex capability of a communication node.

11. The first node of claim 9,
wherein the first node is one of:
a base station;
a terminal; or
an integrated access and backhaul (IAB) node including a mobile terminal (MT) and a distributed unit (DU).

12. The first node of claim 11,
wherein the mobile terminal (MT) of the IAB node acquires a first duplex slot pattern A of a serving cell A where it is located, and the distributed unit (DU) of the IAB node acquires a first duplex slot pattern B of its serving cell B,
wherein the first duplex slot pattern A and the first duplex slot pattern B indicate the first duplex slot pattern in the same transmission direction or respectively indicate the first duplex slot patterns in different transmission directions, and
wherein the transmission direction includes uplink and/or downlink.

13. The first node of claim 9, wherein the controller is further configured to:
obtain information including at least one of an uplink minimum scheduling delay and/or a downlink minimum scheduling delay for scheduling physical transmission on a specific time-domain resource, an uplink maximum scheduling delay and/or a downlink maximum scheduling delay for scheduling physical transmission on a specific time-domain resource, or the scheduling delay configuration for uplink physical transmission and/or downlink physical transmission of a specific time-domain resource,
wherein the specific time-domain resource is a time-domain resource related to the first duplex transmission,
wherein the scheduling delay indicates the time-domain interval between the time unit where the scheduling grant information is transmitted and the time unit of scheduled physical transmission, and
wherein the physical transmission includes transmission of at least one of the following: a physical uplink shared channel (PUSCH), a physical downlink shared channel (PDSCH), a channel state information reference signal (CSI-RS), or a sounding reference signal (SRS).

14. The first node of claim 9, wherein the controller is further configured to:
receive downlink control information (DCI) and/or high-layer signaling of the scheduling grant, and
obtain the configuration of uplink and/or downlink invalid symbol(s) within one or more slots,
wherein after obtaining the configuration of downlink rate matching pattern(s) for downlink transmission, the first node applies the configuration of downlink rate matching on a specific physical resource which includes the physical resource related to the first duplex transmission or the physical resource related to the first duplex transmission in a specific transmission direction, wherein the specific transmission direction is downlink.

15. The first node of claim 14,
wherein the controller is further configured to obtain a user group downlink control information (DCI) for determining uplink and/or downlink invalid symbol(s) within one or more slots and applying the configuration of uplink and/or downlink invalid symbol(s) on the specific physical resource including at least one of the physical resource related to the first duplex transmission and the physical resource related to the first duplex transmission in the specific transmission direction, wherein the specific transmission direction includes uplink and/or downlink,
wherein, in case that the first node is an integrated access and backhaul (IAB) node including a mobile terminal (MT) and a distributed unit (DU), an uplink minimum scheduling delay and/or a downlink minimum scheduling delay for scheduling physical transmission on a specific time-domain resource are acquired by the MT of the IAB node, while an uplink maximum scheduling delay and/or a downlink maximum scheduling delay for scheduling physical transmission on a specific time-domain resource are acquired by the DU of the IAB node, wherein the DU of the IAB node is provided with the configuration of specific reference signal(s), the specific reference signal(s) includes specific downlink reference signal(s) sent by the DU of the IAB node or specific uplink reference signal(s) sent by the MT of the IAB node, wherein the specific downlink reference signal(s) include at least one of a downlink demodulation reference signal, a channel state information reference signal (CSI-RS) and a downlink reference signal related to the first duplex transmission; and the specific uplink reference signal(s) include at least one of an uplink demodulation reference signal, a sounding reference signal and an uplink reference signal related to the first duplex transmission,
wherein the controller is further configured to reporting a request related to the first duplex transmission which includes scheduling request for a first duplex transmission,
wherein the scheduling request for first duplex transmission is for at least one of the following first duplex transmission cases: a first duplex transmission request that the DU of the IAB node receives and transmits signals at the same time, a request that the DU of the IAB node performs downlink transmission on the physical resource where the MT of the IAB node performs downlink reception or possibly performs downlink reception, and a request that the DU of the IAB node performs uplink reception on the physical resource where the MT of the IAB node performs uplink transmission or possibly performs uplink transmission,
wherein configuration related to the first duplex transmission which includes the configuration of reference signal(s) or the configuration of invalid resource(s), is reported by the first node, and
wherein the reference signal(s) include uplink demodulation reference signal(s) or downlink demodulation reference signal(s).
